(19) United States
(12) Patent Application Publication
(10) Pub. No.: US 2022/0309314 A1
(43) Pub. Date: Sep. 29, 2022

(54) Artificial Intelligence Processor Architecture For Dynamic Scaling Of Neural Network Quantization

(71) Applicant: QUALCOMM Incorporated, San Diego, CA (US)

(72) Inventors: Hee Jun PARK, San Diego, CA (US); Eric Wayne MAHURIN, Austin, TX (US); Tijmen Pieter Frederik BLANKEVOORT, Amsterdam (NL)

(21) Appl. No.: 17/210,644

(22) Filed: Mar. 24, 2021

(51) Int. Cl. G06N 3/04; G06N 3/063

(52) U.S. Cl. CPC G06N 3/04; G06N 3/063

(57) ABSTRACT

Various embodiments include methods and devices for processing a neural network by an artificial intelligence (AI) processor. Embodiments may include receiving an AI processor operating condition information, dynamically adjusting an AI quantization level for a segment of a neural network in response to the operating condition information, and processing the segment of the neural network quantization using the adjusted AI quantization level.

### BACKGROUND

Modern computing systems are running multiple neural networks on a system-on-chip (SoC) leading to burdensome neural network loads for the processors of the SoC. Despite processor architecture optimization for running neural networks, heat remains a limiting factor for neural network processing under heavy workloads because heat management is implemented by curtailing operating frequencies of the processor affecting processing performance. Curtailing operating frequencies in mission critical systems can cause critical issues that can result in poor user experience, product quality, operational safety, etc.

### SUMMARY

Various disclosed aspects may include apparatuses and methods for processing a neural network by an artificial intelligence (AI) processor. Various aspects may include receiving an AI processor operating condition information, dynamically adjusting an AI quantization level for a segment of the neural network in response to the operating condition information, and processing the segment of the neural network using the adjusted AI quantization level.

In some aspects, dynamically adjusting the AI quantization level for the segment of the neural network may include increasing the AI quantization level in response to the operating condition information indicating a level of an operating condition that increased constraint of a processing ability of the AI processor, and decreasing the AI quantization level in response to operating condition information indicating a level of the operating condition that decreased constraint of the processing ability of the AI processor.

In some aspects, the operating condition information may be at least one of the group of a temperature, a power consumption, an operating frequency, or a utilization of processing units.

In some aspects, dynamically adjusting the AI quantization level for the segment of the neural network may include adjusting the AI quantization level for quantizing weight values to be processed by the segment of the neural network.

In some aspects, dynamically adjusting the AI quantization level for the segment of the neural network may include adjusting the AI quantization level for quantizing activation values to be processed by the segment of the neural network.

In some aspects, dynamically adjusting the AI quantization level for the segment of the neural network may include adjusting the AI quantization level for quantizing weight values and activation values to be processed by the segment of the neural network.

In some aspects, the AI quantization level may be configured to indicate dynamic bits of a value to be processed by the neural network to quantize, and processing the segment of the neural network using the adjusted AI quantization level may include bypassing portions of a multiplier accumulator (MAC) associated with the dynamic bits of the value.

Some aspects may further include determining an AI quality of service (QoS) value using AI QoS factors, and determining the AI quantization level to achieve the AI QoS value. In some aspects, the AI QoS value may represent a target for accuracy of a result generated by the AI processor and throughput (e.g., inferences per second) of the AI processor.

Further aspects may include an AI processor including dynamic quantization controller and a MAC array configured to perform operations of any of the methods summarized above. Further aspects may include a computing device having an AI processor including a dynamic quantization controller and a MAC array configured to perform operations of any of the methods summarized above. Further aspects may include an AI processor including means for performing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIGS. 2A and 2B are component block diagrams illustrating example artificial intelligence (AI) processors having dynamic neural network quantization architectures suitable for implementing various embodiments.

FIG. 3 is a component block diagram illustrating an example system-on-chip (SoC) having dynamic neural network quantization architecture suitable for implementing various embodiments.

FIGS. 4A and 4B are graph diagrams illustrating an example AI quality of service (QoS) relationships suitable for implementing various embodiments.

FIG. 5 is a graph diagram illustrating an example benefit in AI processor operational frequency from implementing dynamic neural network quantization architecture in various embodiments.

FIG. 6 is a graph comparison diagram illustrating an example benefit in AI processor operational frequency from implementing a dynamic neural network quantization architecture in accordance with various embodiments.

FIG. 7 is a component schematic diagram illustrating an example of bypass in a multiplier accumulator (MAC) in a dynamic neural network quantization architecture suitable for implementing various embodiments.

FIG. 8 is a process flow diagram illustrating a method for AI QoS determination according to an embodiment.

FIG. 9 is a process flow diagram illustrating a method for dynamic neural network quantization architecture configuration control according to an embodiment.

FIG. 10 is a process flow diagram illustrating a method for dynamic neural network quantization architecture reconfiguration according to an embodiment.

FIG. 11 is a component block diagram illustrating an example mobile computing device suitable for implementing an AI processor in accordance with the various embodiments.

FIG. 12 is a component block diagram illustrating an example mobile computing device suitable for implementing an AI processor in accordance with the various embodiments.

FIG. 13 is a component block diagram illustrating an example server suitable for implementing an AI processor in accordance with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments may include methods, and computing devices implementing such methods for dynamically configuring neural network quantization architecture. Some embodiments may include dynamic neural network quantization logic hardware configured to change quantization, masking, and/or neural network pruning based on operating conditions of an artificial intelligence (AI) processor, system-on-chip (SoC) having an AI processor, memory accessed by an AI processor, and/or other peripherals of an AI processor. Some embodiments may include configuring the dynamic neural network quantization logic for quantization of activation and weight values based on a number of dynamic bits for dynamic quantization. Some embodiments may include configuring the dynamic neural network quantization logic for masking of activation and weight values and bypass of portions of multiplier accumulator (MAC) array MACs based on a number of dynamic bits for bypass. Some embodiments may include configuring the dynamic neural network quantization logic for masking of weight values and bypass of entire MACs based on a threshold weight value for neural network pruning. Some embodiments may include determining whether to configure the dynamic neural network quantization logic and using an AI quality of service (QoS) value incorporating AI processor result accuracy and AI processor responsiveness to implement the configuration of the dynamic neural network quantization logic.

The term “dynamic bit(s)” is used herein to refer to bits of an activation value and/or a weight value for configuring the dynamic neural network quantization logics for quantization of activation and weight values, and/or for configuring the dynamic neural network quantization logics for masking of activation and weight values and bypass of portions of MACs. In some embodiments, the dynamic bit(s) may be any number of least significant bits of the activation value and/or the weight value.

The term “AI quantization level” is described herein using relative terms in which multiple AI quantization levels are described relative to each other. For example, a higher AI quantization level may relate to increased quantization with more dynamic bits masked (zeroed) for an activation value and/or a weight value than a lower AI quantization level. A lower AI quantization level may relate to decreased quantization with less dynamic bits masked (zeroed) for an activation value and/or a weight value than a higher AI quantization level.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers (such as in vehicles and other larger systems), computerized vehicles (e.g., partially or fully autonomous terrestrial, aerial, and/or aquatic vehicles, such as passenger vehicles, commercial vehicles, recreational vehicles, military vehicles, drones, etc.), servers, multimedia computers, and game consoles.

Neural networks are implemented in an array of computing devices, which can execute multiple neural networks concurrently. AI processors are implemented with architectures specifically designed for execution of neural networks, such as in neural processing units, and/or AI processors are advantageous for execution of neural networks, such as in digital signal processing units. AI processor architectures can result in greater processing performance, such as in latency, accuracy, power consumption, etc. when compared to other processor architectures, such as central processing units and graphics processing units. However, AI processors typically have high power density and under heavy workloads, frequently resulting from executing multiple neural networks concurrently, AI processors can suffer from performance degradation brought on by thermal buildup. An example of such an AI processor executing multiple neural networks is in an automobile with an active driver-assistance system in which the AI processor concurrently runs one set of neural networks for vehicle navigation/operation and another set of neural networks for monitoring a driver. Current strategies for thermal management in AI processors include curtailing an operating frequency of an AI processor based on a sensed temperature.

Curtailing operating frequencies of AI processors in mission critical systems can cause critical issues that can result in poor user experience, product quality, operational safety, etc. AI processor throughput is an important factor in AI processor performance that is adversely affected by curtailing operating frequency. Another important factor in AI processor performance is AI processor result accuracy. This accuracy may not be affected by curtailing operating frequency as the operating frequency may affect the speed at which AI processor operations execute rather than whether the AI processor operations execute fully, such as using all of the provided data and completing the processing of the data. Thus, by curtailing operating frequency in response to thermal buildup, AI processor throughput is sacrificed while AI processor result accuracy may not be sacrificed. For some systems, such as self-driving automobiles, drones, and other self-propelled machines, throughput is critically important and, consequently, a tradeoff of some accuracy for faster throughput is acceptable and even desirable.

Similar issues occur when operating frequency is curtailed in response to other adverse operating conditions, such as power constraints of a power source for an AI processor and/or performance constraints of a computing device having the AI processor. For clarity and ease of explanation, the examples herein are described in terms of thermal buildup but such references are not intended to limit the scope of the claims and descriptions herein.

Further, quantization applied to neural network inputs, including activation values and weight values, is static in conventional systems. A neural network developer preconfigures quantization features of a neural network in a compiler or in development tools, and sets quantization for the neural network to a fixed significant bit.

In some embodiments described herein, a dynamically configuring neural network quantization architecture may be configured to manage AI processor throughput and AI processor result accuracy under adverse operating conditions, such as thermal buildup. While being an important factor in AI processor performance, some losses in AI processor result accuracy may be acceptable in many situations. AI processor result accuracy may be affected by modifying the inputs, activation and weight values, to a neural network executing on an AI processor. Sacrificing some AI processor accuracy may allow for AI processor throughput to be less affected in response to thermal buildup than when compared to responding to thermal buildup by curtailing AI processor throughput alone. In some embodiments, sacrificing some AI processor accuracy and AI processor throughput may provide larger power and/or main memory traffic reductions than when curtailing AI processor throughput alone.

In some embodiments, a dynamic neural network quantization logic may be configured at runtime to change the quantization, masking, and/or neural network pruning based on operating conditions, such as temperature, power consumption, utilization of processing units, etc. of an AI processor, SoC having an AI processor, memory accessed by an AI processor, and/or other peripherals of an AI processor. Some embodiments may include configuring the dynamic neural network quantization logic for quantization of activation and weight values based on a number of dynamic bits for dynamic quantization. Some embodiments may include configuring the dynamic neural network quantization logic for masking of activation and weight values and bypass of portions of MACs based on a number of dynamic bits for bypass. Some embodiments may include configuring the dynamic neural network quantization logic for masking of weight values and bypass of entire MACs based on a threshold weight value for neural network pruning. In some embodiments, the dynamic neural network quantization logic may be configured to change preconfigured quantization of a neural network based on the operating conditions as needed.

Some embodiments may include a dynamic quantization controller configured to generate and send a dynamic quantization signal to any number and combination of AI processors, dynamic neural network quantization logics, and MACs. The dynamic quantization controller may determine the parameters for implementing the quantization, masking, and/or neural network pruning by the AI processors, dynamic neural network quantization logics, and MACs. The dynamic quantization controller may determine these parameters based on an AI quantization level incorporating AI processor result accuracy and AI processor responsiveness.

Some embodiments may include an AI QoS manager configured to determine whether to implement dynamic neural network quantization reconfiguration of the AI processors, dynamic neural network quantization logics, and/or MACs. The AI QoS manager may receive data signals representing AI QoS factors. AI QoS factors may be the operating conditions upon which dynamic neural network quantization logic reconfiguration, to change the quantization, masking, and/or neural network pruning, may be based. These operating conditions may include temperature, power consumption, utilization of processing units, etc. of an AI processor. SoC having an AI processor, memory accessed by an AI processor, and/or other peripherals of an AI processor. The AI QoS manager may determine an AI QoS value that accounts for AI processor throughput, AI processor result accuracy, and/or AI processor operational frequency to achieve for an AI processor under certain operating conditions. The AI QoS value may be used to determine an AI quantization level that accounts for AI processor throughput and AI processor result accuracy as a result of configuring the dynamic neural network quantization logic, and/or an AI processor operational frequency for the operating conditions.

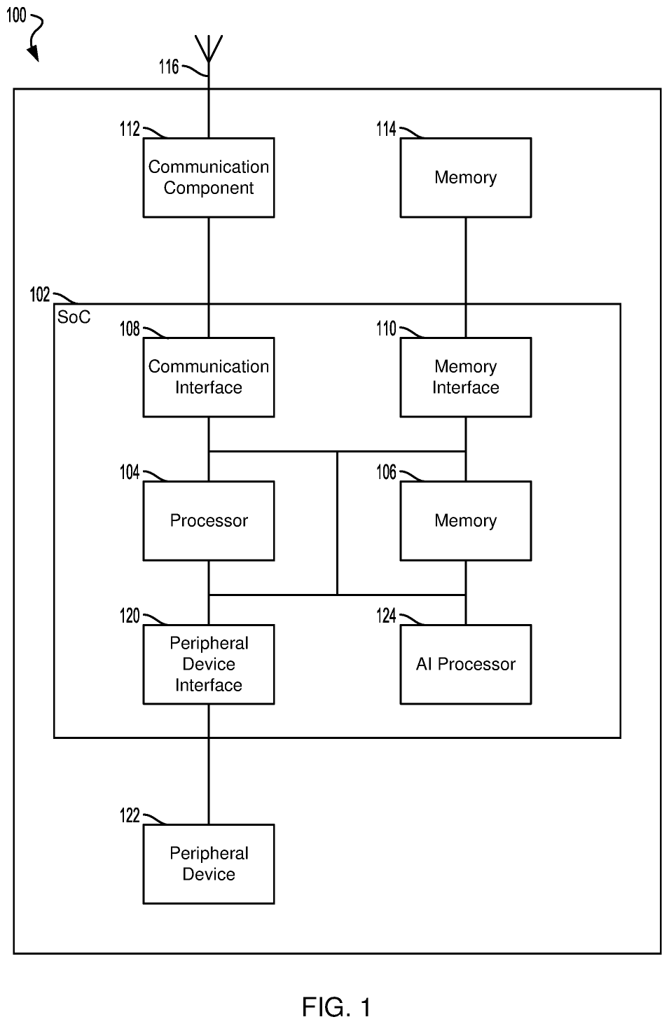

FIG. 1 illustrates a system including a computing device 100 suitable for use with various embodiments. The computing device 100 may include an SoC 102 with a processor 104, a memory 106, a communication interface 108, a memory interface 110, and a peripheral device interface 120. The computing device 100 may further include a communication component 112, such as a wired or wireless modem, a memory 114, an antenna 116 for establishing a wireless communication link, and/or a peripheral device 122. The processor 104 may include any of a variety of processing devices, for example a number of processor cores.

The term “system-on-chip” or “SoC” is used herein to refer to a set of interconnected electronic circuits typically, but not exclusively, including a processing device, a memory, and a communication interface. A processing device may include a variety of different types of processors 104 and/or processor cores, such as a general purpose processor, a central processing unit (CPU), a digital signal processor (DSP), a graphics processing unit (GPU), an accelerated processing unit (APU), a secure processing unit (SPU), a subsystem processor of specific components of the computing device, such as an image processor for a camera subsystem or a display processor for a display, an auxiliary processor, a single-core processor, a multicore processor, a controller, and/or a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and/or time references. Integrated circuits may be configured such that the components of the integrated circuit reside on a single piece of semiconductor material, such as silicon.

The memory 106 of the SoC 102 may be a volatile or non-volatile memory configured for storing data and processor-executable code for access by the processor 104 or by other components of SoC 102, including an AI processor 124. The computing device 100 and/or SoC 102 may include one or more memories 106 configured for various purposes. One or more memories 106 may include volatile memories such as random access memory (RAM) or main memory, or cache memory. These memories 106 may be configured to temporarily hold a limited amount of data received from a data sensor or subsystem, data and/or processor-executable code instructions that are requested from non-volatile memory, loaded to the memories 106 from non-volatile memory, and/or intermediary processing data and/or processor-executable code instructions produced by the processor 104 and/or AI processor 124 and temporarily stored for future quick access without being stored in non-volatile memory. The memory 106 may be configured to store data and processor-executable code, at least temporarily, that is loaded to the memory 106 from another memory device, such as another memory 106 or memory 114, for access by one or more of the processors 104 or by other components of SoC 102, including the AI processor 124. In some embodiments, any number and combination of memories 106 may include one-time programmable or read-only memory.

The memory interface 110 and the memory 114 may work in unison to allow the computing device 100 to store data and processor-executable code on a volatile and/or non-volatile storage medium, and retrieve data and processor-executable code from the volatile and/or non-volatile storage medium. The memory 114 may be configured much like an embodiment of the memory 106 in which the memory 114 may store the data or processor-executable code for access by one or more of the processors 104 or by other components of SoC 102, including the AI processor 124. The memory interface 110 may control access to the memory 114 and allow the processor 104 or other components of the SoC 12, including the AI processor 124, to read data from and write data to the memory 114.

An SoC 102 may also include an AI processor 124. The AI processor 124 may be a processor 104, a portion of a processor 104, and/or a standalone component of the SoC 102. The AI processor 124 may be configured to execute neural networks for processing activation values and weight values on the computing device 100. The computing device 100 may also include AI processors 124 that are not associated with the SoC 102. Such AI processors 124 may be standalone components of the computing device 100 and/or integrated into other SoCs 102.

Some or all of the components of the computing device 100 and/or the SoC 102 may be arranged differently and/or combined while still serving the functions of the various embodiments. The computing device 100 may not be limited to one of each of the components, and multiple instances of each component may be included in various configurations of the computing device 100.

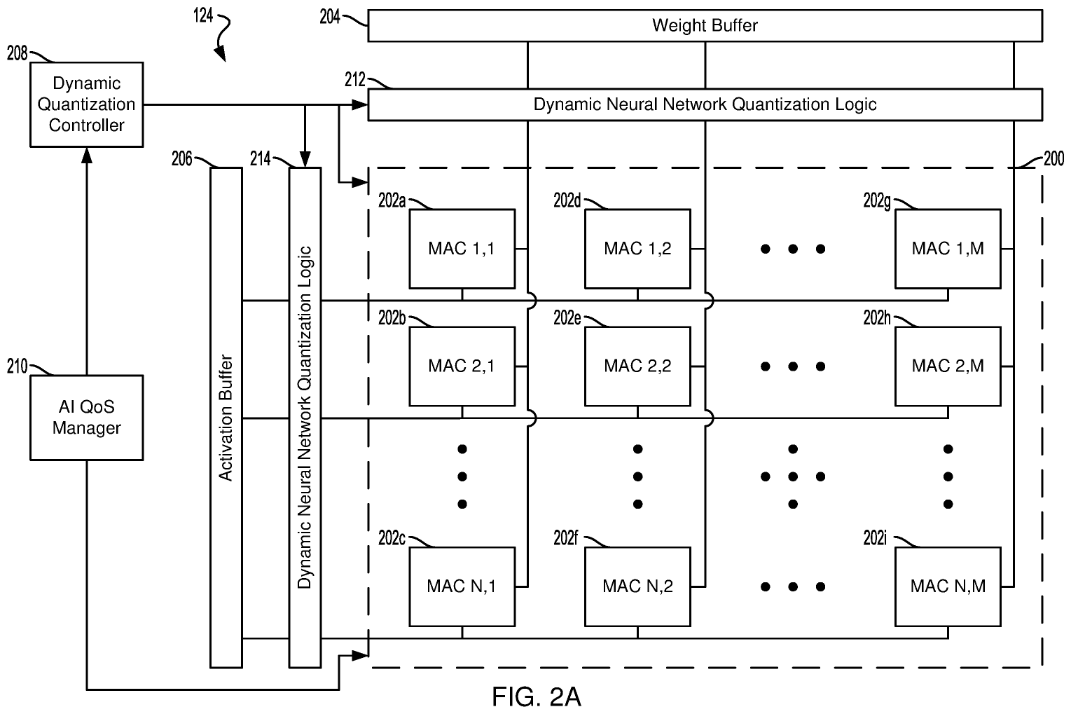

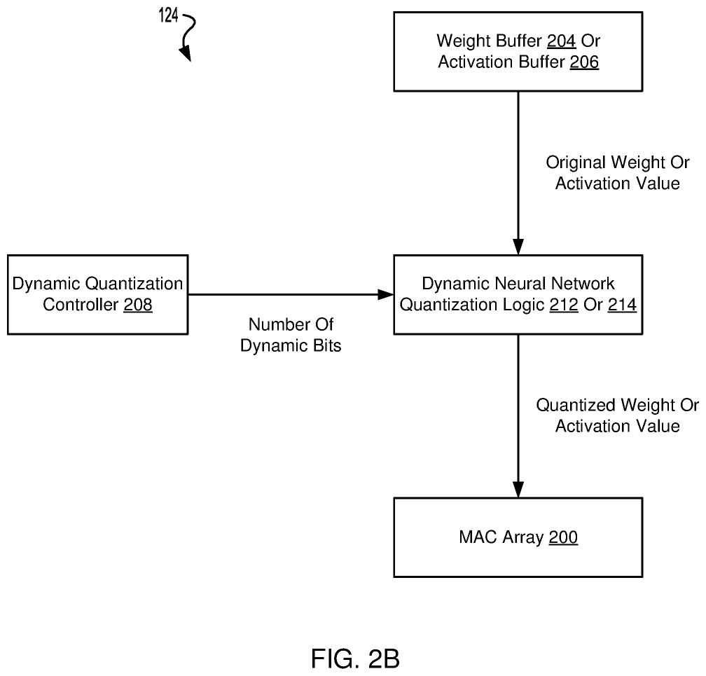

FIG. 2A illustrates an example AI processor having a dynamic neural network quantization architecture suitable for implementing various embodiments. With reference to FIGS. 1 and 2A, an AI processor 124 may include any number and combination of MAC arrays 200, weight buffers 204, activation buffers 206, dynamic quantization controllers 208, AI QoS managers 210, and dynamic neural network quantization logics 212, 214. A MAC array 200 may include any number and combination of MACs 202a-202i.

The AI processor 124 may be configured to execute neural networks. The executed neural networks may process activation and weight values. The AI processor 124 may receive and store activation values at an activation buffer 206 and weight values at a weight buffer 204. Generally, the MAC array 200 may receive the activation values from the activation buffer 206 and the weight values from the weight buffer 204, and process the activation and weight values by multiplying and accumulating the activation and weight values. For example, each MAC 202a-202i may receive any number of combinations of activation and weight values, and multiply the bits of each received combination of activation and weight values and accumulate the results of the multiplications. A convert (CVT) module (not shown) of the AI processor 124 may modify the MAC results by performing functions using the MAC results, such as scaling, adding bias, and/or applying activation functions (e.g., sigmoid, ReLU, Gaussian, SoftMax, etc.). The MACs 202a-202i may receive multiple combinations of activation and weight values by receiving each combination serially. As described further herein, in some embodiments, the activation and weight values may be modified prior to receipt by the MACs 202a-202i. Also as described further herein, in some embodiments, the MACs 202a-202i may be modified for processing the activation and weight values.

An AI QoS manager 210 may be configured as hardware, software executed by the AI processor 124, and/or a combination of hardware and software executed by the AI processor 124. The AI QoS manager 210 may be configured to determine whether to implement dynamic neural network quantization reconfiguration of the AI processor 124, dynamic neural network quantization logics 212, 214, and/or MACs 202a-202i. The AI QoS manager 210 may be communicatively connected to any number and combination of sensors (not shown), such as temperature sensors, voltage sensors, current sensors, etc. and processors 104. The AI QoS manager 210 may receive data signals representing AI QoS factors from these communicatively connected sensors and/or processors 104. AI QoS factors may be operating conditions upon which dynamic neural network quantization logic reconfiguration decisions to change the quantization, masking, and/or neural network pruning may be based. These operating conditions may include temperature, power consumption, utilization of processing units, performance, etc. of the AI processor 124, the SoC 102 having the AI processor 124, memory 106, 114 accessed by the AI processor 124, and/or other peripherals 122 of the AI processor 124. For example, a temperature operating condition may be a temperature sensor value representative of a temperature at a location on the AI processor 124. As a further example, a power operating condition may be a value representative of a peak of a power rail compared to a power supply and/or a power management integrated circuit capability, and/or a battery charge status. As a further example, a performance operating condition may be value representative of utilization, fully idle time, frames-per-second, and/or end-to-end latency of the AI processor 124.

The AI QoS manager 210 may be configured to determine from the operating conditions whether to implement dynamic neural network quantization reconfiguration. The AI QoS manager 210 may determine to implement dynamic neural network quantization reconfiguration based on a level of an operating condition that increased constraint of a processing ability of the AI processor 124. The AI QoS manager 210 may determine to implement dynamic neural network quantization reconfiguration based on a level of an operating condition that decreased constraint of the processing ability of the AI processor 124. Constraint of the processing ability of the AI processor 124 may be caused by an operating condition level, such as a level of thermal buildup, power consumption, utilization of processing units, and the like that impact the ability of the AI processor 124 to maintain a level of processing ability.

In some embodiments, the AI QoS manager 210 may be configured with any number and combination of algorithms, thresholds, look up tables, etc. for determining from the operating conditions whether to implement dynamic neural network quantization reconfiguration. For, example, the AI QoS manager 210 may compare a received operating condition to a threshold value for the operating condition. In response to the operating condition comparing unfavorably to the threshold value for the operating condition, such as by exceeding the threshold value, the AI QoS manager 210 may determine to implement dynamic neural network quantization reconfiguration. Such an unfavorable comparison may indicate to the AI QoS manager 210 that the operating condition increased constraint of the processing ability of the AI processor 124. In response to the operating condition comparing favorably to the threshold value for the operating condition, such as by falling short of the threshold value, the AI QoS manager 210 may determine to implement dynamic neural network quantization reconfiguration. Such a favorable comparison may indicate to the AI QoS manager 210 that the operating condition decreased constraint of the processing ability of the AI processor 124. In some embodiments, the AI QoS manager 210 may be configured to compare multiple received operating conditions to multiple thresholds for the operating conditions and determine to implement dynamic neural network quantization reconfiguration based on a combination of unfavorable and/or favorable comparison results. In some embodiments, the AI processor 124 may be configured with an algorithm to combine multiple received operating conditions and compare the result of the algorithm to a threshold. In some embodiments, the multiple received operating conditions may be of the same and/or different types. In some embodiments, the multiple received operating conditions may be for a specific time and/or over a time period.

For dynamic neural network quantization reconfiguration, the AI QoS manager 210 may determine an AI QoS value to be achieved by the AI processor 124. The AI QoS value may be configured to account for AI processor throughput and AI processor result accuracy to achieve as a result of the dynamic neural network quantization reconfiguration and/or AI processor operational frequency of the AI processor 124 under certain operating conditions. The AI QoS value may represent user perceptible levels and/or mission critical acceptable levels of latency, quality, accuracy, etc. for the AI processor 124. In some embodiments, the AI QoS manager 210 may be configured with any number and combination of algorithms, thresholds, look up tables, etc. for determining the AI QoS value from the operating conditions. For example, the AI QoS manager 210 may determine an AI QoS value that accounts for AI processor throughput and AI processor result accuracy as a target to achieve for an AI processor 124 exhibiting a temperature exceeding a temperature threshold. As a further example, the AI QoS manager 210 may determine an AI QoS value that accounts for AI processor throughput and AI processor result accuracy as a target to achieve for an AI processor 124 exhibiting a current (power consumption) exceeding a current threshold. As a further example, the AI QoS manager 210 may determine an AI QoS value that accounts for AI processor throughput and AI processor result accuracy as a target to achieve for an AI processor 124 exhibiting a throughput value and/or a utilization value exceeding a throughput threshold and/or a utilization threshold. The foregoing examples described in terms of the operating conditions exceeding thresholds are not intended to limit the scope of the claims or the specification, and are similarly applicable to embodiments in which the operating conditions fall short of the thresholds.

As described further herein, the dynamic quantization controller 208 may determine how to dynamically configure the AI processor 124, dynamic neural network quantization logics 212, 214, and/or MACs 202a-202i to achieve the AI QoS value. In some embodiments, the AI QoS manager 210 may be configured to execute an algorithm that calculates an AI quantization level to achieve the AI QoS value from values representing AI processor accuracy and AI processor throughput. For example, the algorithm may be a summation and/or a minimum function of the AI processor accuracy and AI processor throughput. As a further example, the value representing AI processor accuracy may include an error value of the output of the neural network executed by the AI processor 124, and the value representing AI processor throughput may include a value of inferences per time period produced by the AI processor 124. The algorithm may be weighted to favor either AI processor accuracy or AI processor throughput. In some embodiments, the weights may be associated with any number and combination of operating conditions of the AI processor 124, the SoC 102, the memory 106, 114, and/or other peripherals 122. In some embodiments, the AI quantization level may be calculated in conjunction with an AI processor operational frequency to achieve the AI QoS value. The AI quantization level may change relative to a previously calculated AI quantization level based on the effect of the operating conditions on the processing ability of the AI processor 124. For example, an operating condition indicating to the AI QoS manager 210 an increased constraint of the processing ability of the AI processor 124 may result in increasing the AI quantization level. As another example, an operating condition indicating to the AI QoS manager 210 a decreased constraint of the processing ability of the AI processor 124 may result in decreasing the AI quantization level.

In some embodiments, the AI QoS manager 210 may also determine whether to implement traditional curtailing of the AI processor operating frequency alone or in combination with dynamic neural network quantization reconfiguration. For example, some of the threshold values for operating conditions may be associated with traditional curtailing of the AI processor operating frequency and/or dynamic neural network quantization reconfiguration. Unfavorable comparison of any number or combination of the received operating conditions to the threshold values associated with curtailing of the AI processor operating frequency and/or dynamic neural network quantization reconfiguration may trigger the AI QoS manager 210 to determine to implement curtailing of the AI processor operating frequency and/or dynamic neural network quantization reconfiguration. In some embodiments, the AI QoS manager 210 may be adapted to control the operating frequency of the MAC array 200.

The AI QoS manager 210 may generate and send an AI quantization level signal, having the AI quantization level, to a dynamic quantization controller 208. The AI quantization level signal may trigger the dynamic quantization controller 208 to determine parameters for implementing dynamic neural network quantization reconfiguration and provide the AI quantization level as an input for the parameter determination. In some embodiments, the AI quantization level signal may also include the operating conditions which caused the AI QoS manager 210 to determine to implement dynamic neural network quantization reconfiguration. The operating conditions may also be inputs for determining the parameters for implementing dynamic neural network quantization reconfiguration. In some embodiments, the operating conditions may be represented by a value of the operating condition and/or a value representing the result of an algorithm using the operating condition, a comparison of the operating condition to the threshold, a value from a look up table for the operating condition, etc. For example, the value representing the result of the comparison may include a difference between a value of the operating condition and a value of the threshold. In some embodiments, the AI QoS manager 210 may be adapted to vary the AI quantization level used by the MAC array 200, where for example the varying may be by setting a particular AI quantization level or instructing to increase or decrease the present level.

In some embodiments, the AI QoS manager 210 may also generate and send an AI frequency signal to the MAC array 200. The AI frequency signal may trigger the MAC array 200 to implement curtailment of the AI processor operating frequency. In some embodiments, the MAC array 200 may be configured with means for implementing curtailment of the AI processor operating frequency. In some embodiments, the AI QoS manager 210 may generate and send either or both of the AI quantization level signal and the AI frequency signal.

The dynamic quantization controller 208 may be configured as hardware, software executed by the AI processor 124, and/or a combination of hardware and software executed by the AI processor 124. The dynamic quantization controller 208 may be configured to determine parameters for the dynamic neural network quantization reconfiguration. In some embodiments, the dynamic quantization controller 208 may be preconfigured to determine the parameters for any number and combination of specific types of dynamic neural network quantization reconfiguration. In some embodiments, the dynamic quantization controller 208 may be configured to determine which parameters to determine for any number and combination of types of dynamic neural network quantization reconfiguration.

Determining which parameters to determine for the types of dynamic neural network quantization reconfiguration may control which types of dynamic neural network quantization reconfiguration may be implemented. The types of dynamic neural network quantization reconfiguration may include: configuring the dynamic neural network quantization logics 212, 214 for quantization of activation and weight values, configuring the dynamic neural network quantization logics 212, 214 for masking of activation and weight values and the MAC array 200 and/or MACs 202a-202i for bypass of portions of MACs 202a-202i, and configuring the dynamic neural network quantization logic 212 for masking of weight values and MAC array 200 and/or MACs 202a-202i for bypass of entire MACs 202a-202i. In some embodiments, the dynamic quantization controller 208 may be configured to determine a parameter of a number of dynamic bits for configuring the dynamic neural network quantization logics 212, 214 for quantization of activation and weight values. In some embodiments, the dynamic quantization controller 208 may be configured to determine an additional parameter of a number of dynamic bits for configuring the dynamic neural network quantization logics 212, 214 for masking of activation and weight values and bypass of portions of MACs 202a-202i. In some embodiments, the dynamic quantization controller 208 may be configured to determine an additional parameter of a threshold weight value for configuring the dynamic neural network quantization logic 212 for masking of weight values and bypass of entire MACs 202a-202i.

The AI quantization level may be different from a previously calculated AI quantization level and result in differences in the determined parameter for implementing dynamic neural network quantization reconfiguration. For example, increasing the AI quantization level may cause the dynamic quantization controller 208 to determine an increased number of dynamic bits and/or decreased threshold weight value for configuring the dynamic neural network quantization logics 212, 214. Increasing the number of dynamic bits and/or decreasing the threshold weight value may cause fewer bits and/or fewer MACs 202a-202i to be used to implement calculations of a neural network, which may reduce the accuracy of the neural network's inference results. As another example, decreasing the AI quantization level may cause the dynamic quantization controller 208 to determine a decreased number of dynamic bits and/or increased threshold weight value for configuring the dynamic neural network quantization logics 212, 214. Decreasing the number of dynamic bits and/or increasing the threshold weight value may cause more bits and/or more MACs 202a-202i to be used to implement calculations of a neural network, which may increase the accuracy of the neural network's inference results.

In some embodiments, the dynamic neural network quantization logics 212, 214 may dynamically implement the AI quantization level using the parameters determined by the dynamic quantization controller 208, in which the implementation may be by masking, quantizing, bypassing, or any other suitable means. The dynamic quantization controller 208 may receive the AI quantization level signal from the AI QoS manager 210. The dynamic quantization controller 208 may use the AI quantization level received with the AI quantization level signal to determine the parameters for the dynamic neural network quantization reconfiguration. In some embodiments, the dynamic quantization controller 208 may also use the operating conditions received with the AI quantization level signal to determine the parameters for the dynamic neural network quantization reconfiguration. In some embodiments, the dynamic quantization controller 208 may be configured with algorithms, thresholds, look up tables, etc. for determining which parameters and/or the values of the parameters of the dynamic neural network quantization reconfiguration to use based on the AI quantization level and/or the operating conditions. For example, the dynamic quantization controller 208 may use the AI quantization level and/or operating conditions as inputs to an algorithm that may output a number of dynamic bits to use for quantization of activation and weight values. In some embodiments, an additional algorithm may be used and may output a number of dynamic bits for masking of activation and weight values and bypass of portions of MACs 202a-202i. In some embodiments, an additional algorithm may be used and may output a threshold weight value for masking of weight values and bypass of entire MACs 202a-202i.

The dynamic quantization controller 208 may generate and send a dynamic quantization signal, having the parameters for the dynamic neural network quantization reconfiguration, to dynamic neural network quantization logics 212, 214. The dynamic quantization signal may trigger the dynamic neural network quantization logics 212, 214 to implement dynamic neural network quantization reconfiguration and provide the parameters for implementing the dynamic neural network quantization reconfiguration. In some embodiments, the dynamic quantization controller 208 may send the dynamic quantization signal to the MAC array 200. The dynamic quantization signal may trigger the MAC array 200 to implement dynamic neural network quantization reconfiguration and provide the parameters for implementing the dynamic neural network quantization reconfiguration. In some embodiments, the dynamic quantization signal may include an indicator of a type of dynamic neural network quantization reconfiguration to implement. In some embodiments, the indicator of type of dynamic neural network quantization reconfiguration may be the parameters for the dynamic neural network quantization reconfiguration.

The dynamic neural network quantization logics 212, 214 may be implemented in hardware. The dynamic neural network quantization logics 212, 214 may be configured to quantize the activation and weight values received from the activation buffer 206 and the weight buffer 204, such as by rounding the activation and weight values. Quantization of the activation and weight values may be implemented using any type of rounding, such as rounding up or down to a dynamic bit, rounding up or down to a significant bit, rounding up or down to a nearest value, rounding up or down to a specific value, etc. For clarity and ease of explanation, the examples of quantization are described in terms of rounding to a dynamic bit but do not limit the scope of the claims and descriptions herein. The dynamic neural network quantization logics 212, 214 may provide the quantized activation and weight values to the MAC array 200. The dynamic neural network quantization logics 212, 214 may be configured to receive the dynamic quantization signal and implement the dynamic neural network quantization reconfiguration.

The dynamic neural network quantization logics 212, 214 may receive the dynamic quantization signal from the dynamic quantization controller 208 and determine the parameters for the dynamic neural network quantization reconfiguration. The dynamic neural network quantization logics 212, 214 may also determine the type of dynamic neural network quantization reconfiguration to implement from the dynamic quantization signal, which may include configuring the dynamic neural network quantization logics 212, 214 for a specific type of quantization. In some embodiments the type of dynamic neural network quantization reconfiguration to implement may also include configuring the dynamic neural network quantization logics 212, 214 for masking of the activation and/or weight values. In some embodiments, masking of the activation and weight values may include replacing a certain number of dynamic bits with zero values. In some embodiments, masking of the weight values may include replacing all of the bits with zero values.

The dynamic quantization signal may include the parameter of a number of dynamic bits for configuring the dynamic neural network quantization logics 212, 214 for quantization of activation and weight values. The dynamic neural network quantization logics 212, 214 may be configured to quantize the activation and weight values by rounding the bits of the activation and weight values to the number of dynamic bits indicated by the dynamic quantization signal.

The dynamic neural network quantization logics 212, 214 may include configurable logic gates that may be configured to round the bits of the activation and weight values to the number of dynamic bits. In some embodiments, the logic gates may be configured to output zero values for the least significant bits of the activation and weight values up to and/or including the number of dynamic bits. In some embodiments, the logic gates may be configured to output the values of the most significant bits of the activation and weight values including and/or following the number of dynamic bits. For example, each bit of an activation or weight value may be input to the logic gates sequentially, such as least significant bit to most significant bit. The logic gates may output zero values for the least significant bits of the activation and weight values up to and/or including the number of dynamic bits indicated by the parameter. The logic gates may output the values for the most significant bits of the activation and weight values including and/or following the number of dynamic bits indicated by the parameter. As a further example, the weight values and the activation values may be 8-bit integers, and the number of dynamic bits may indicate to the dynamic neural network quantization logics 212, 214 to round the least significant half of the 8-bit integers. The number of dynamic bits may be different than a default number of dynamic bits or a pervious number of dynamic bits to round to for a default or previous configuration of the dynamic neural network quantization logics 212, 214. Therefore, the configuration of the logic gates may also be different from default or previous configurations of the logic gates.

The dynamic quantization signal may include the parameter of a number of dynamic bits for configuring the dynamic neural network quantization logics 212, 214 for masking of activation and weight values and bypass of portions of MACs 202a-202i. The dynamic neural network quantization logics 212, 214 may be configured to quantize the activation and weight values by masking the number of dynamic bits of the activation and weight values indicated by the dynamic quantization signal.

The dynamic neural network quantization logics 212, 214 may include configurable logic gates that may be configured to mask the number of dynamic bits of the activation and weight values. In some embodiments, the logic gates may be configured to output zero values for the least significant bits of the activation and weight values up to and/or including the number of dynamic bits. In some embodiments, the logic gates may be configured to output the values of the most significant bits of the activation and weight values including and/or following the number of dynamic bits. For example, each bit of an activation and weight values may be input to the logic gates sequentially, such as least significant bit to most significant bit. The logic gates may output zero values for the least significant bits of the activation and weight values up to and/or including the number of dynamic bits indicated by the parameter. The logic gates may output the values for the most significant bits of the activation and weight values including and/or following the number of dynamic bits indicated by the parameter. The number of dynamic bits may be different than a default number of dynamic bits or a pervious number of dynamic bits to mask for a default or previous configuration of the dynamic neural network quantization logics 212, 214. Therefore, the configuration of the logic gates may also be different from default or previous configurations of the logic gates.

In some embodiments, the logic gates may be clock gated so that the logic gates do not receive and/or do not output the least significant bits of the activation and weight values up to and/or including the number of dynamic bits. Clock gating the logic gates may effectively replace the least significant bits of the activation and weight values with zero values as the MAC array 200 may not receive the values of the least significant bits of the activation and weight values.

In some embodiments, the dynamic neural network quantization logics 212, 214 may signal to the MAC array 200 the parameter of the number of dynamic bits for bypass of portions of MACs 202a-202i. In some embodiments, the dynamic neural network quantization logics 212, 214 may signal to the MAC array 200 which of the bits of the activation and weight values are masked. In some embodiments, the lack of a signal for a bit of the activation and weight values may be the signal from the dynamic neural network quantization logics 212, 214 to the MAC array 200.

In some embodiments, the MAC array 200 may receive the dynamic quantization signal including the parameter of a number of dynamic bits for configuring the dynamic neural network quantization logics 212, 214 for masking of activation and weight values and bypass of portions of MACs 202a-202i. In some embodiments the MAC array 200 may receive the signal of the parameter of a number of dynamic bits and or which dynamic bits for bypass of portions of MACs 202a-202i from the dynamic neural network quantization logics 212, 214. The MAC array 200 may be configured to bypass portions of MACs 202a-202i for dynamic bits of the activation and weight values indicated by the dynamic quantization signal and/or the signal from the dynamic neural network quantization logics 212, 214. These dynamic bits may correspond to bits of the activation and weight values masked by the dynamic neural network quantization logics 212, 214.

The MACs 202a-202i may include logic gates configured to implement multiply and accumulate functions. In some embodiments, the MAC array 200 may clock gate the logic gates of the MACs 202a-202i configured to multiply and accumulate the bits of the activation and weight values that correspond to the number of dynamic bits indicated by the parameter of the dynamic quantization signal. In some embodiments, the MAC array 200 may clock gate the logic gates of the MACs 202a-202i configured to multiply and accumulate the bits of the activation and weight values that correspond to the number of dynamic bits and/or the specific dynamic bits indicated by the signal from the dynamic neural network quantization logics 212, 214.

In some embodiments, the MAC array 200 may power collapse the logic gates of the MACs 202a-202i configured to multiply and accumulate the bits of the activation and weight values that correspond to the number of dynamic bits indicated by the parameter of the dynamic quantization signal. In some embodiments, the MAC array 200 may power collapse the logic gates of the MACs 202a-202i configured to multiply and accumulate the bits of the activation and weight values that correspond to the number of dynamic bits and/or the specific dynamic bits indicated by the signal from the dynamic neural network quantization logics 212, 214.

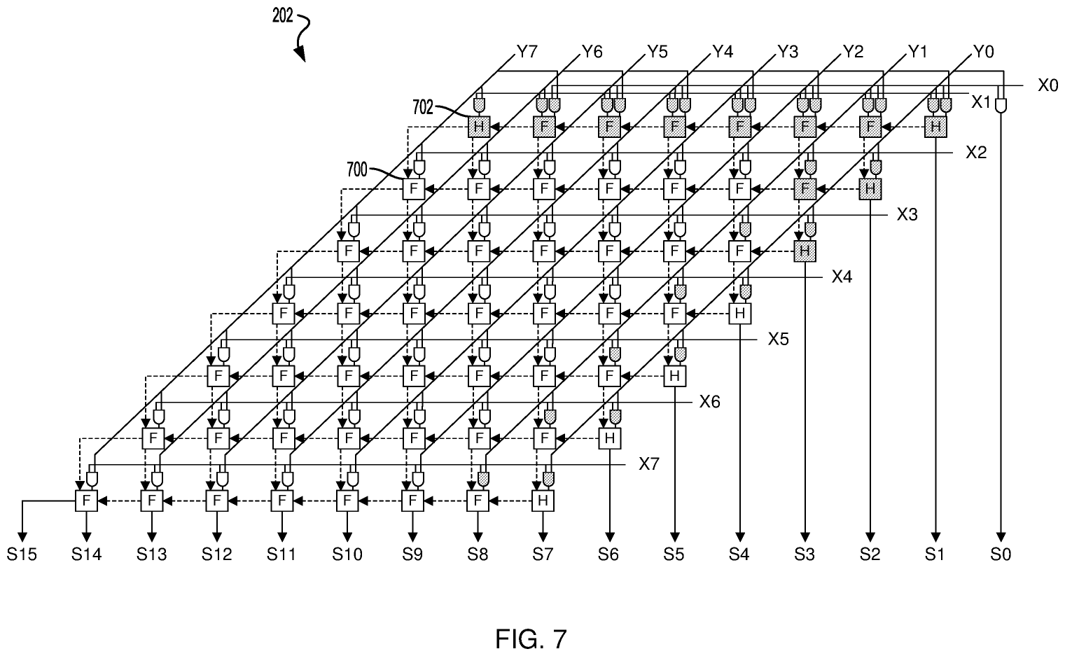

By clock gating and/or powering down the logic gates of the MACs 202a-202i, the MACs 202a-202i may not receive the bits of the activation and weight values that correspond to the number of dynamic bits or specific dynamic bits, effectively masking these bits. A further example of clock gating and/or powering down the logic gates of the MACs 202a-202i is described herein with reference to FIG. 7.

The dynamic quantization signal may include the parameter of a threshold weight value for configuring the dynamic neural network quantization logic 212 for masking of weight values and bypass of entire MACs 202a-202i. The dynamic neural network quantization logic 212 may be configured to quantize the weight values by masking all of the bits of the weight values based on comparison of the weight values to the threshold weight value indicated by the dynamic quantization signal.

The dynamic neural network quantization logic 212 may include configurable logic gates that may be configured to compare weight values received from the weight buffer 204 to the threshold weight value and mask the weight values that compare unfavorably, such as by being less than or less than and equal to, the threshold weight value. In some embodiments, the comparison may be of the absolute value of a weight value to the threshold weight value. In some embodiments, the logic gates may be configured to output zero values for all of the bits of the weight values that compare unfavorably to the threshold weight value. All of the bits may be a different number of bits than a default number of bits or a pervious number of bits to mask for a default or previous configuration of the dynamic neural network quantization logic 212. Therefore, the configuration of the logic gates may also be different from default or previous configurations of the logic gates.

In some embodiments, the logic gates may be clock gated so that the logic gates do not receive and/or do not output the bits of the weight values that compare unfavorably to the threshold weight value. Clock gating the logic gates may effectively replace the bits of the weight values with zero values as the MAC array 200 may not receive the values of the bits of the weight values. In some embodiments, the dynamic neural network quantization logic 212 may signal to the MAC array 200 which of the bits of the weight values are masked. In some embodiments, the lack of a signal for a bit of the weight values may be the signal from the dynamic neural network quantization logic 212 to the MAC array 200.

In some embodiments, the MAC array 200 may receive the signal from the dynamic neural network quantization logic 212 for which bits of the weight values are masked. The MAC array 200 may interpret masked entire weight values as signals to bypass entire MACs 202a-202i. The MAC array 200 may be configured to bypass MACs 202a-202i for weight values indicated by the signal from the dynamic neural network quantization logic 212. These weight values may correspond to weight values masked by the dynamic neural network quantization logic 212.

The MACs 202a-202i may include logic gates configured to implement multiply and accumulate functions. In some embodiments, the MAC array 200 may clock gate the logic gates of the MACs 202a-202i configured to multiply and accumulate the bits of the weight values that correspond to the masked weight values. In some embodiments, the MAC array 200 may power collapse the logic gates of the MACs 202a-202i configured to multiply and accumulate the bits of the weight values that correspond to masked weight values. By clock gating and/or powering down the logic gates of the MACs 202a-202i, the MACs 202a-202i may not receive the bits of the activation and weight values that correspond to the masked weight values.

Masking weight values by the dynamic neural network quantization logic 212 and/or clock gating and/or powering down MACs 202a-202i may prune a neural network executed by the MAC array 200. Removing weight values and MAC operations form the neural network may effectively remove synapses and nodes from the neural network. The weight threshold may be determined on a basis that weight values that compare unfavorably to the weight threshold when removed from the execution of the neural network may cause an acceptable loss in accuracy in the AI processor results.

FIG. 2B illustrates an embodiment of the AI processor 124 illustrated in FIG. 2A. With reference to FIGS. 1-2B, the AI processor 124 may include the dynamic neural network quantization logics 212, 214, which may be implemented as hardware circuit logic, rather than as a software tool or in a compiler. The activation buffer 206 and the weight buffer 204, the dynamic quantization controller 208, hardware dynamic neural network quantization logics 212, 214 and the MAC array 200 may function and interact as described with reference to FIG. 2A.

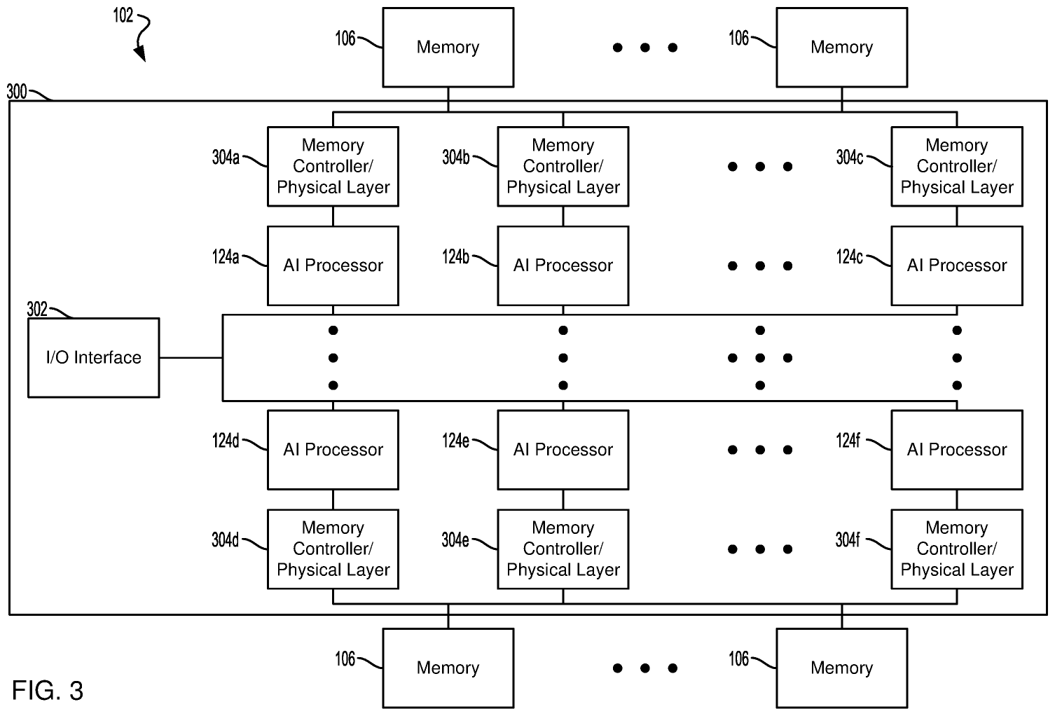

FIG. 3 illustrates an example SoC having dynamic neural network quantization architecture suitable for implementing various embodiments. With reference to FIGS. 1-3, an SoC 102 may include any number and combination of AI processing subsystems 300 and memories 106. An AI processing subsystem 300 may include any number and combination of AI processors 124a-124f, input/output (I/O) interfaces 302, and memory controllers/physical layer components 304a-304f.

As discussed herein with reference to an AI processor (e.g., 124), in some embodiments dynamic neural network quantization reconfiguration may be implemented with an AI processor. In some embodiments, dynamic neural network quantization reconfiguration may be implemented, at least in part, prior to the activation and weight values being received by and AI processor 124a-124f.

An I/O interface 302 may be configured to control communications between the AI processing subsystem 300 and other components of a computing device (e.g., 100), including processors (e.g., 104), communication interfaces (e.g., communication interfaces (e.g., 108), communication components (e.g., 112), peripheral device interfaces (e.g., 120), peripheral devices (e.g., 120), etc. Some such communications may include receiving activation values. In some embodiments, the I/O interface 302 may be configured to include and/or implement the functions of an AI QoS manager (e.g., 210), a dynamic quantization controller (e.g., 208), and/or a dynamic neural network quantization logic (e.g., 212). In some embodiments, the I/O interface 302 the may be configured to implement the functions of an AI QoS manager, a dynamic quantization controller, and/or a dynamic neural network quantization logic through hardware, software executing on the I/O interface 302, and/or hardware and software executing on the I/O interface 302.

A memory controller/physical layer component 304a-304f may be configured to control communications between the AI processors 124a-124f, the memories 106, and/or memories local to the AI processing subsystem 300 and/or AI processors 124a-124f. Some such communications may include read and writes of weight and activation values from and to the memory 106.

In some embodiments, the memory controller/physical layer component 304a-304f may be configured to include and/or implement the functions of an AI QoS manager, a dynamic quantization controller, and/or a dynamic neural network quantization logic. For example, the memory controller/physical layer component 304a-304f may quantize and/or mask the activation values and/or weight values during an initial memory 106 write or read of the weight and/or activation values. As a further example, the memory controller/physical layer component 304a-304f may quantize and/or mask the weight values during writing the weight values to the local memory when transferring the weight values from the memory 106. As a further example, the memory controller/physical layer component 304a-304f may quantize and/or mask the activation values while the activation values are produced.

In some embodiments, the memory controller/physical layer component 304a-304f the may be configured to implement the functions of an AI QoS manager, a dynamic quantization controller, and/or a dynamic neural network quantization logic through hardware, software executing on the memory controller/physical layer component 304a-304f, and/or hardware and software executing on the memory controller/physical layer component 304a-304f.

The I/O interface 302 and/or the memory controller/physical layer component 304a-304f may be configured to provide the quantized and/or masked weight and/or activation values to the AI processors 124a-124f. In some embodiments, the I/O interface 302 and/or the memory controller/physical layer component 304a-304f may be configured to not provide the fully masked weight values to the AI processors 124a-124f.

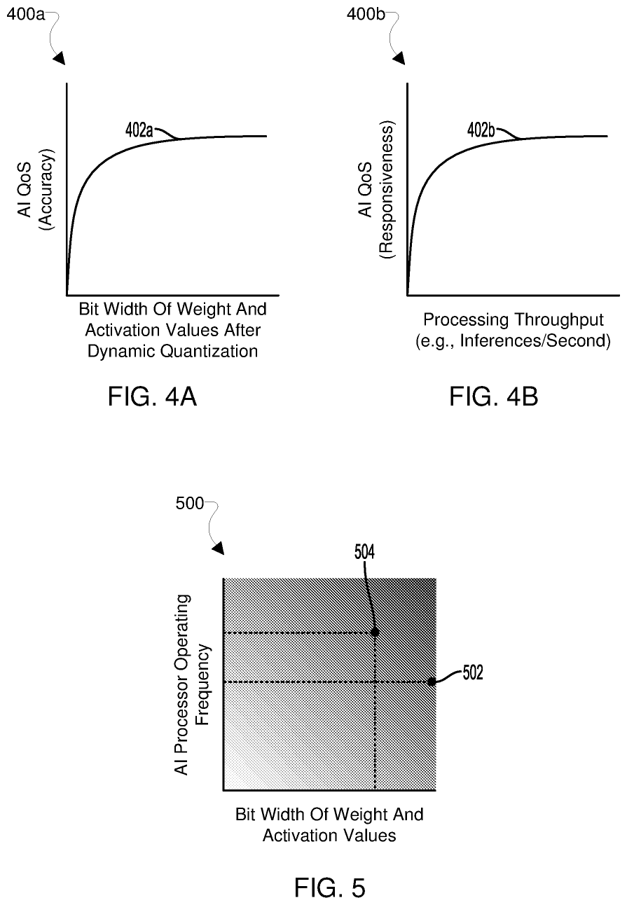

FIGS. 4A and 4B illustrate example AI QoS relationships suitable for implementing various embodiments. With reference to FIGS. 1-4B, for dynamic neural network quantization reconfiguration, the AI QoS manager (e.g., 210) may determine an AI QoS value that accounts for AI processor throughput and AI processor result accuracy to achieve as a result of the dynamic neural network quantization reconfiguration under certain operating conditions.

FIG. 4A illustrates a graph 400a representing measurements of AI processor result accuracy in terms of AI QoS values, on the vertical axis, in relation to bit widths of weight values and activation values quantized using dynamic neural network quantization reconfiguration, on the horizontal axis. The curve 402a illustrates that the larger the bit width of the weight values and the activation values, the more accurate the AI processor results may be. However, the curve 402a also illustrates a diminishing return on the bit width of the weight values and the activation values because as the slope of the curve 402a approaches zero the larger the bit width of the weight values and the activation values becomes. Thus, for some bit widths of the weight values and the activation values smaller than the largest bit width, the accuracy of the AI processor results may exhibit negligible change.

The curve 402a further illustrates that at a point where some bit widths of the weight values and the activation values that are even smaller than the largest bit width, the slope of the curve 402a increases at a greater rate. Thus, for some bit widths of the weight values and the activation values that are even smaller than the largest bit width, the accuracy of the AI processor results may exhibit non-negligible change. For bit widths of the weight values and the activation values that exhibit negligible change, the accuracy of the AI processor results and dynamic neural network quantization reconfiguration may be implemented to quantize the weight values and the activation values and still achieve an acceptable level of AI processor result accuracy.

FIG. 4B illustrates a graph 400b representing measurements of AI processor responsiveness, which may also be referred to as latency, in terms of AI QoS values, on the vertical axis, in relation to AI processor throughput for an implementation of dynamic neural network quantization reconfiguration, on the horizontal axis. In some embodiments, throughput may include a value of inferences per time period produced by the AI processor, such as inferences per second. Throughput may increase for an implementation of dynamic neural network quantization reconfiguration in response to smaller bit widths of activation and/or weight values.

The curve 402b illustrates that the higher the AI processor throughput, the AI processor may be more responsive. However, the curve 402b also illustrates a diminishing return on the AI processor throughput because as the slope of the curve 402b approaches zero the higher the AI processor throughput becomes. Thus, for some AI processor throughputs lower than the highest AI processor throughput, the responsiveness of the AI processor may exhibit negligible change.

The curve 402b further illustrates that at a point, where some AI processor throughputs that are even lower than the highest AI processor throughput, the slope of the curve 402b increases at a greater rate. Thus, for some AI processor throughputs that are even lower than the highest AI processor throughput, the responsiveness of the AI processor may exhibit non-negligible change. For AI processor throughputs that exhibit negligible change, the responsiveness of the AI processor and dynamic neural network quantization reconfiguration may be implemented to quantize the activation and/or weight values and still achieve an acceptable level of AI processor responsiveness.

FIG. 5 illustrates an example benefit in AI processor operational frequency implementing dynamic neural network quantization architecture in various embodiments. With reference to FIGS. 1-5, for dynamic neural network quantization reconfiguration, the dynamic neural network quantization logics (e.g., 212, 214), the I/O interface (e.g., 302), and/or the memory controller/physical layer component (e.g., 304a-304f) may implement dynamic neural network quantization reconfiguration to achieve levels of AI processor throughput and/or AI processor result accuracy.

FIG. 5 illustrates a graph 500 representing measurements of AI processor operational frequency, which may affect AI processor throughput, on the vertical axis, in relation to bit widths of weight values and activation values, on the horizontal axis. The graph 500 is also shaded to represent an operating condition under which the AI processor may operate. For example, the operating condition may be temperature of the AI processor, and the darker shading may represent higher temperatures, such that the lowest temperatures may be at the origin point of the graph and the hottest temperature may be opposite the origin point. For the point 502, dynamic neural network quantization reconfiguration is not implemented, and the weight value and the activation values may remain at the largest bit width and the only means of reducing the temperature is to reduce the operating frequency of the AI processor. Excessive reduction of the operating frequency of the AI processor will result in poor AI QoS and latency that will cause critical issues in mission critical systems, such as automotive systems. For the point 504, dynamic neural network quantization reconfiguration is implemented, and to achieve similar temperature reduction illustrated by the point 502, both the operating frequency of the AI processor may be reduced and the bit width of the weight value and the activation values may be quantized to be smaller than the largest bit width. The point 504 illustrates that by reducing the bit width of the weight value and the activation values, using dynamic neural network quantization reconfiguration, the AI processor operating frequency may be higher as compared to the AI processor operating frequency of the point 502 while the operating condition of the temperature at both points 502, 504 is similar. Thus, dynamic neural network quantization reconfiguration may allow for greater AI processor performance, such as AI processor throughput, at the similar operating conditions, such as AI processor temperature, when compared to not using dynamic neural network quantization reconfiguration.

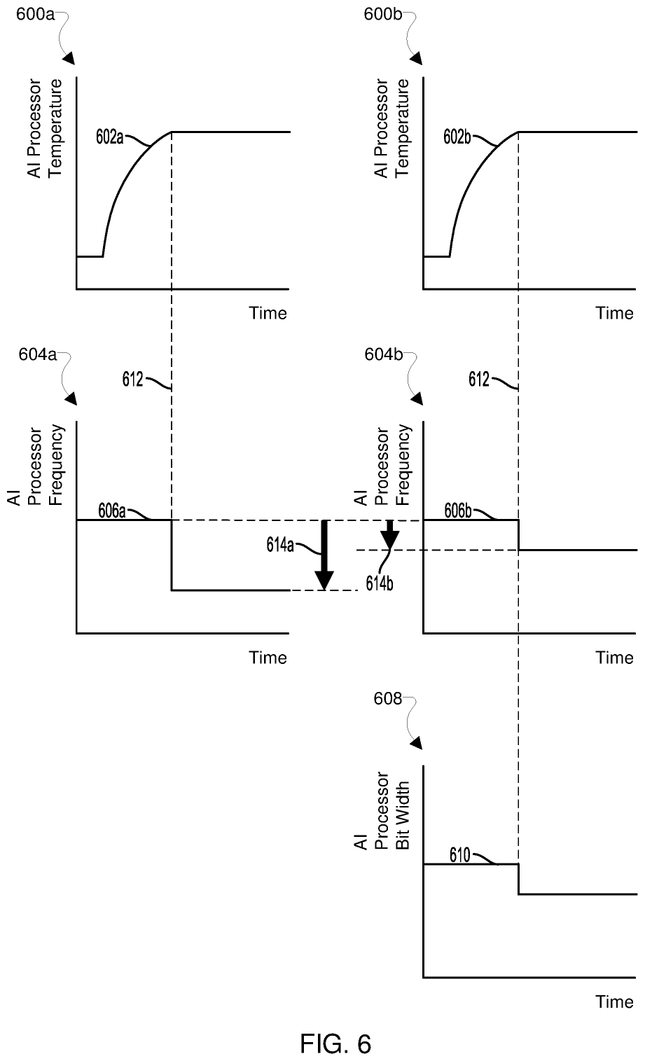

FIG. 6 illustrates an example benefit in AI processor operational frequency implementing dynamic neural network quantization architecture in various embodiments. With reference to FIGS. 1-6, for dynamic neural network quantization reconfiguration, the dynamic neural network quantization logics (e.g., 212, 214), the I/O interface (e.g., 302), and/or the memory controller/physical layer component (e.g., 304a-304t) may implement dynamic neural network quantization reconfiguration to achieve levels of AI processor throughput and/or AI processor result accuracy. FIG. 6 illustrates graphs 600a, 600b, 604a, 604b, 608 representing measurements of AI processor operating conditions, which may affect AI processor throughput, plotted in relation to time. Graph 600a represents measurements of AI processor temperature without implementing dynamic neural network quantization reconfiguration, on the vertical axis, in relation to time, on the horizontal axis. Graph 600b represents measurements of AI processor temperature with implementation of dynamic neural network quantization reconfiguration, on the vertical axis, in relation to time, on the horizontal axis. Graph 604a represents measurements of AI processor frequency without implementing dynamic neural network quantization reconfiguration, on the vertical axis, in relation to time, on the horizontal axis. Graph 604b represents measurements of AI processor frequency with implementation of dynamic neural network quantization reconfiguration, on the vertical axis, in relation to time, on the horizontal axis. Graph 608 represents measurements of AI processor bit width, for activation and/or weight values, with implementation of dynamic neural network quantization reconfiguration, on the vertical axis, in relation to time, on the horizontal axis.

Prior to a time 612, the AI processor temperature 602a in graph 600a may increase while the AI processor frequency 606a in graph 604a may remain steady. Similarly, prior to the time 612, the AI processor temperature 602b in graph 600b may increase while the AI processor frequency 606b in graph 604b and the AI processor bit width 610 in graph 608 may remain steady. Reasons for the increase in AI processor temperature 602a, 602b without change in AI processor frequency 606a, 606b and/or the AI processor bit width 610 may include increased workload for an AI processor (e.g., 124, 124a-124f).

At time 612, the AI processor temperature 602a may peak and the AI processor frequency 606a may reduce. The lower AI processor frequency 606a may cause the AI processor temperature 602a to stop rising as the AI processor may generate less heat while consuming less power at the lower AI processor frequency 606a than before time 612. Similarly, at time 612, the AI processor temperature 602b may peak and the AI processor frequency 606b may reduce. However, at time 612, the AI processor bit width 610 may also reduce. The lower AI processor frequency 606b and the lower AI processor bit width 610 may cause the AI processor temperature 602b to stop rising as the AI processor may generate less heat while consuming less power at the lower AI processor frequency 606b and processing smaller bit width data than before time 612.

In comparison to each other, the difference in AI processor frequency 614a from before and at time 612 may be greater than the difference in AI processor frequency 614b from before and at time 612. Reducing the AI processor bit width 610 in conjunction with reducing the AI processor operating frequency 606b may allow for the reduction in the AI processor operating frequency 606b to be less than the reduction in the AI processor operating frequency 606a when reducing the AI processor operating frequency 606a alone. Reducing the AI processor bit width 610 the AI processor operating frequency 606b may yield similar benefits in terms of the AI processor temperature 602a, 602b as reducing the AI processor operating frequency 606a alone, but may also provide the benefit of greater AI processor operating frequency 606b, which may affect AI processor throughput.

FIG. 7 illustrates an example of bypass in a MAC in a dynamic neural network quantization architecture for implementing various embodiments. With reference to FIGS. 1-7, a MAC 202 may include a logic circuit including variety of logic components 700, 702, such as any number and combination of AND gates, full adders (labeled “F” in FIG. 7), and/or half adders (labeled “H” in FIG. 7). The example illustrated in FIG. 7 shows a MAC 202 having a logic circuit normally configured for 8-bit multiplication and accumulation functions. However, the MAC 202 may be normally configured for multiplication and accumulation functions of any bit width data, and the example illustrated in FIG. 7 but do not limit the scope of the claims and descriptions herein.

In some embodiments, the lines X₀-X₇ may Y₀-Y₇ provide inputs of activation values and weight values to the MAC 202. X₀ and Y₀ may represent the least significant bits and X₇ and Y₇ may represent the most significant bits of the activation values and weight values. As described herein, dynamic neural network quantization reconfiguration may include quantizing and/or masking any number of dynamic bits of the activation and/or weight values. Quantizing and/or masking of the bits of the activation and/or weight values may round and/or replace the bits of the weight values to and/or with zero values. As such multiplication of a quantized and/or masked bit of an activation and/or weight value and another bit of an activation and/or weight value may result in a zero value. Given the known result of the multiplication of a quantized and/or masked activation and/or weight value, there may be no need to actually implement the multiplication and addition of the results. Therefore, an AI processor (e.g., 124, 124a-123f), including a MAC array (e.g., 200), may clock gate to off the logic components 702 for multiplication of multiplication of the quantized and/or masked activation and/or weight values and addition of the results. Clock gating the logic components 702 for multiplication of multiplication of the masked weight values and addition of the results may reduce circuit switching power loss, also referred to as dynamic power reduction.

In the example illustrated in FIG. 7 the two least significant bits of the activation and weight values, on lines X₀, X₁, Y₀, or Y₁, are masked. The shaded corresponding logic components 702, the logic components 702 that receive X₀, X₁, Y₀, or Y₁ and/or a result of an operation for X₀, X₁, Y₀, and/or Y₁ as an input, are shaded to indicate that they are clock gated to off. The remaining, not shaded logic components 700 are not shaded to represent that they are not clock gated to off.

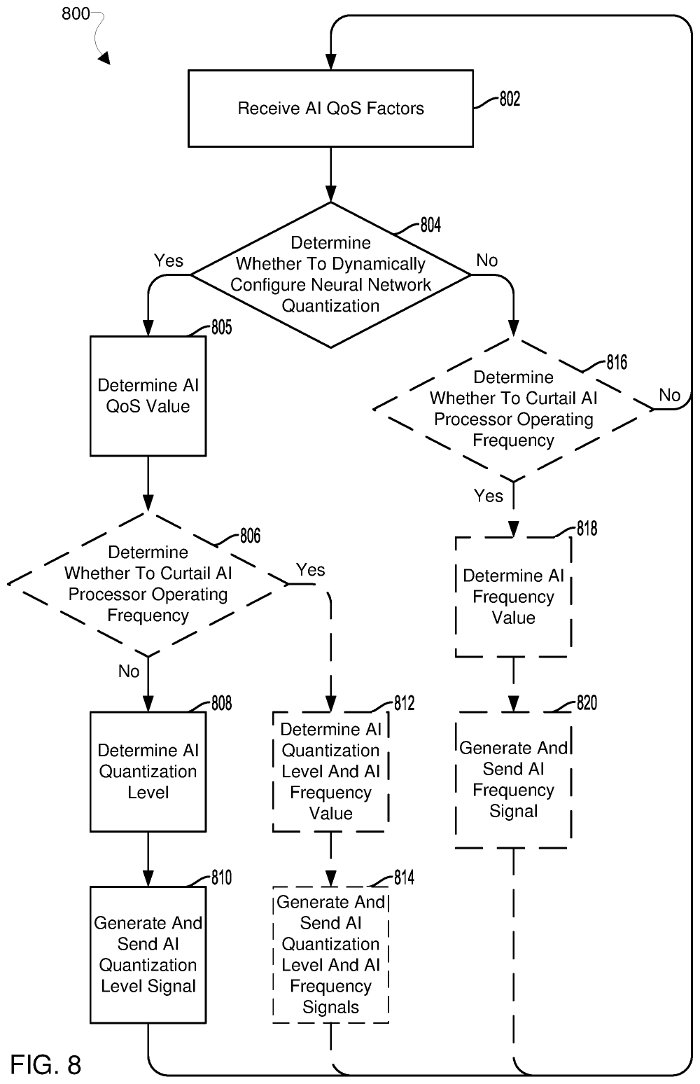

FIG. 8 illustrates a method 800 for AI QoS determination according to an embodiment. With reference to FIGS. 1-8, the method 800 may be implemented in a computing device (e.g., 100), in general purpose hardware, in dedicated hardware (e.g., 210), in software executing in a processor (e.g., processor 104. AI processor 124, AI QoS manager 210, AI processing subsystem 300, AI processor 124a-124f. I/O interface 302, memory controller/physical layer component 304a-304f), or in a combination of a software-configured processor and dedicated hardware, such as a processor executing software within a dynamic neural network quantization system (e.g., AI processor 124, AI QoS manager 210, AI processing subsystem 300. AI processor 124a-124f, I/O interface 302, memory controller/physical layer component 304a-304f) that includes other individual components, and various memory/cache controllers. In order to encompass the alternative reconfigurations enabled in various embodiments, the hardware implementing the method 800 is referred to herein as an “AI QoS device.”

In block 802, the AI QoS device may receive AI QoS factors. The AI QoS device may be communicatively connected to any number and combination of sensors, such as temperature sensors, voltage sensors, current sensors, etc. and processors. The AI QoS device may receive data signals representing AI QoS factors from these communicatively connected sensors and/or processors. AI QoS factors may be the operating conditions upon which dynamic neural network quantization logic reconfiguration, to change the quantization, masking, and/or neural network pruning, may be based. These operating conditions may include temperature, power consumption, utilization of processing units, performance, etc. of an AI processor, an SoC (e.g., 102) having the AI processor, a memory (e.g., 106, 114) accessed by the AI processor, and/or other peripherals (e.g., 122) of the AI processor. For example, temperature may be a temperature sensor value representative of a temperature at a location on the AI processor. As a further example, power may be a value representative of a peak of a power rail compared to a power supply and/or a power management integrated circuit capability, and/or a battery charge status. As a further example, performance may be value representative of utilization, fully idle time, frames-per-second, and/or end-to-end latency of the AI processor. In some embodiments, an AI QoS manager may be configured to receive AI QoS factors in block 802. In some embodiments, an I/O interface and/or memory controller/physical layer component may be configured to receive AI QoS factors in block 802.

In determination block 804, the AI QoS device may determine whether to dynamically configure neural network quantization. In some embodiments, an AI QoS manager may be configured to determine whether to dynamically configure neural network quantization in determination block 804. In some embodiments, an I/O interface and/or memory controller/physical layer component may be configured to determine whether to dynamically configure neural network quantization in determination block 804. The AI QoS device may determine from the operating conditions whether to implement dynamic neural network quantization reconfiguration. The AI QoS device may determine to dynamically configure neural network quantization based on a level of an operating condition that increased constraint of a processing ability of the AI processor. The AI QoS device may determine to implement dynamically configure neural network quantization based on a level of an operating condition that decreased constraint of the processing ability of the AI processor. Constraint of the processing ability of the AI processor may be caused by an operating condition level, such as a level of thermal buildup, power consumption, utilization of processing units, and the like that impact the ability of the AI processor to maintain a level of processing ability.

In some embodiments, the AI QoS device may be configured with any number and combination of algorithms, thresholds, look up tables, etc. for determining from the operating conditions whether to implement dynamic neural network quantization reconfiguration. For, example, the AI QoS device may compare a received operating condition to a threshold value for the operating condition. In response to the operating condition comparing unfavorably to the threshold value for the operating condition, such as by exceeding the threshold value, the AI QoS device may determine to implement dynamic neural network quantization reconfiguration in determination block 804. Such an unfavorable comparison may indicate to the AI QoS device that the operating condition increased constraint of the processing ability of the AI processor. In response to the operating condition comparing favorably to the threshold value for the operating condition, such as by falling short of the threshold value, the AI QoS device may determine to implement dynamic neural network quantization reconfiguration in determination block 804. Such a favorable comparison may indicate to the AI QoS device that the operating condition decreased constraint of the processing ability of the AI processor.

In some embodiments, the AI QoS device may compare multiple received operating conditions to multiple thresholds for the operating conditions and determine to implement dynamic neural network quantization reconfiguration based on a combination of unfavorable and/or favorable comparison results. In some embodiments, the AI device may be configured with an algorithm to combine multiple received operating conditions and compare the result of the algorithm to a threshold. In some embodiments, the multiple received operating conditions may be of the same and/or different types. In some embodiments, the multiple received operating conditions may be for a specific time and/or over a time period.

In response to determining to dynamically configure neural network quantization (i.e., determination block 804=“Yes), the AI QoS device may determine an AI QoS value in block 805. For dynamic neural network quantization reconfiguration, the AI QoS device may determine an AI QoS value to achieve for an AI processor that accounts for AI processor throughput and AI processor result accuracy to achieve as a result of the dynamic neural network quantization reconfiguration and/or AI processor operational frequency of the AI processor under certain operating conditions. The AI QoS value may represent user perceptible levels and/or mission critical acceptable levels of latency, quality, accuracy, etc. for the AI processor.

In some embodiments, the AI QoS device may be configured with any number and combination of algorithms, thresholds, look up tables, etc. for determining the AI QoS value from the operating conditions. For example, the AI QoS device may determine an AI QoS value that accounts for AI processor throughput and AI processor result accuracy as a target to achieve for an AI processor exhibiting a temperature exceeding a temperature threshold. As a further example, the AI QoS device may determine an AI QoS value that accounts for AI processor throughput and AI processor result accuracy as a target to achieve for an AI processor exhibiting a current (power consumption) exceeding a current threshold. As a further example, the AI QoS device may determine an AI QoS value that accounts for AI processor throughput and AI processor result accuracy as a target to achieve for an AI processor exhibiting a throughput value and/or a utilization value exceeding a throughput threshold and/or a utilization threshold. The foregoing examples described in terms of the operating conditions exceeding thresholds are not intended to limit the scope of the claims or the specification, and are similarly applicable to embodiments in which the operating conditions fall short of the thresholds. In some embodiments, an AI QoS manager may be configured to determine an AI QoS value in block 805. In some embodiments, an I/O interface and/or memory controller/physical layer component may be configured to determine an AI QoS value in block 805.

In optional block 806, the AI QoS device may determine whether to curtail the AI processor operating frequency. The AI QoS device may also determine whether to implement traditional curtailing of the AI processor operating frequency alone or in combination with dynamic neural network quantization reconfiguration. For example, some of the threshold values for operating conditions may be associated with traditional curtailing of the AI processor operating frequency and/or dynamic neural network quantization reconfiguration. Unfavorable comparison of any number or combination of the received operating conditions to the threshold values associated with curtailing of the AI processor operating frequency and/or dynamic neural network quantization reconfiguration may trigger the AI QoS device to determine to implement curtailing of the AI processor operating frequency and/or dynamic neural network quantization reconfiguration. In some embodiments, an AI QoS manager may be configured to determine whether to curtail AI processor operating frequency in optional determination block 806. In some embodiments, an I/O interface and/or memory controller/physical layer component may be configured to determine whether to curtail AI processor operating frequency in optional determination block 806.

Following determining the AI QoS value in block 805, or in response to determining not to curtail AI processor operating frequency (i.e., optional determination block 806=“No), the AI QoS device may determine an AI quantization level to achieve the AI QoS value in block 808. The AI QoS device may determine an AI quantization level that accounts for AI processor throughput and AI processor result accuracy to achieve as a result of the dynamic neural network quantization reconfiguration under certain operating conditions. For example, the AI QoS device may determine an AI quantization level that accounts for AI processor throughput and AI processor result accuracy as a target to achieve for an AI processor exhibiting a temperature exceeding a temperature threshold. In some embodiments, the AI QoS device may be configured to execute an algorithm that calculates the AI quantization level from any number or combination of values representing AI processor accuracy and AI processor throughput, such as the AI QoS value. For example, the algorithm may be a summation and/or a minimum function of the AI processor accuracy and AI processor throughput. As a further example, the value representing AI processor accuracy may include an error value of the output of the neural network executed by the AI processor, and the value representing AI processor throughput may include a value of inferences per time period produced by the AI processor. The algorithm may be weighted to favor either AI processor accuracy or AI processor throughput. In some embodiments, the weights may be associated with any number and combination of operating conditions of the AI processor, the SoC having the AI processor, the memory accessed by the AI processor, and/or other peripherals of the AI processor. The AI quantization level may change relative to a previously calculated AI quantization level based on the effect of the operating conditions on the processing ability of the AI processor. For example, an operating condition indicating to the AI QoS device an increased constraint of the processing ability of the AI processor may result in increasing the AI quantization level. As another example, an operating condition indicating to the AI QoS device a decreased constraint of the processing ability of the AI processor may result in decreasing the AI quantization level. In some embodiments, an AI QoS manager may be configured to determine an AI quantization level in block 808. In some embodiments, an I/O interface and/or memory controller/physical layer component may be configured to determine an AI quantization level in block 808.

In block 810, the AI QoS device may generate and send an AI quantization level signal. The AI QoS device may generate and send the AI quantization level signal, having the AI quantization level. In some embodiments, the AI QoS device may send the AI quantization level signal to a dynamic quantization controller (e.g., 208). In some embodiments, the AI QoS device may send the AI quantization level signal to an I/O interface and/or memory controller/physical layer component. The AI quantization level signal may trigger the recipient to determine parameters for implementing dynamic neural network quantization reconfiguration and provide the AI quantization level as an input for the parameter determination. In some embodiments, the AI quantization level signal may also include the operating conditions which caused the AI QoS device to determine to implement dynamic neural network quantization reconfiguration. The operating conditions may also be inputs for determining the parameters for implementing dynamic neural network quantization reconfiguration. In some embodiments, the operating conditions may be represented by a value of the operating condition and/or a value representing the result of an algorithm using the operating condition, a comparison of the operating condition to the threshold, a value from a look up table for the operating condition, etc. For example, the value representing the result of the comparison may include a difference between a value of the operating condition and a value of the threshold. In some embodiments, an AI QoS manager may be configured to generate and send an AI quantization level signal in block 810. In some embodiments, an I/O interface and/or memory controller/physical layer component may be configured to generate and send an AI quantization level signal in block 810. The AI QoS device may repeatedly, periodically, and/or continuously receive AI QoS factors, in block 802.

In response to determining to curtail AI processor operating frequency (i.e., optional determination block 806=“Yes), the AI QoS device may determine an AI quantization level and an AI processor operational frequency value in optional block 812. The AI QoS device may determine an AI quantization level as in block 808. The AI QoS device may similarly determine an AI processor operational frequency value through use of any number and combination of algorithms, thresholds, look up tables, etc. The AI processor operational frequency value may indicate an operational frequency value to which to curtail the AI processor operational frequency. The AI processor operating frequency may be based on the AI QoS value determined in block 805. In some embodiments, the AI quantization level may be calculated in conjunction with an AI processor operational frequency to achieve the AI QoS value. In some embodiments, an AI QoS manager may be configured to determine an AI quantization level and an AI processor operational frequency value in optional block 812. In some embodiments, an I/O interface and/or memory controller/physical layer component may be configured to determine an AI quantization level and an AI processor operational frequency value in optional block 812.

In optional block 814, the AI QoS device may generate and send an AI quantization level signal and an AI frequency signal. The AI QoS device may generate and send an AI quantization level signal as in block 810. The AI QoS device may also generate and send an AI frequency signal to a MAC array (e.g., 200). The AI frequency signal may include the AI processor operational frequency value. The AI frequency signal may trigger the MAC array to implement curtailment of the AI processor operating frequency, for example, using the AI processor operational frequency value. In some embodiments, an AI QoS manager may be configured to generate and send an AI quantization level signal and an AI frequency signal in optional block 814. In some embodiments, an I/O interface and/or memory controller/physical layer component may be configured to generate and send an AI quantization level signal and an AI frequency signal in optional block 814. The AI QoS device may repeatedly, periodically, and/or continuously receive AI QoS factors, in block 802.

In response to determining not to dynamically configure neural network quantization (i.e., determination block 804=“No), the AI QoS device may determine whether to curtail AI processor operating frequency in optional determination block 816. The AI QoS device may determine whether to curtail AI processor operating frequency as in optional determination block 806. In some embodiments, an AI QoS manager may be configured to determine whether to curtail AI processor operating frequency in optional determination block 806. In some embodiments, an I/O interface and/or memory controller/physical layer component may be configured to determine whether to curtail AI processor operating frequency in optional determination block 806.

In response to determining to curtail AI processor operating frequency (i.e., optional determination block 816=“Yes), the AI QoS device may determine an AI processor operational frequency value in optional block 818. The AI QoS device may determine an AI processor operational frequency as in optional block 812. In some embodiments, an AI QoS manager may be configured to determine AI processor operational frequency value in optional block 818. In some embodiments, an I/O interface and/or memory controller/physical layer component may be configured to determine an AI processor operational frequency value in optional block 818.

In optional block 820, the AI QoS device may generate and send an AI frequency signal. The AI QoS device may generate and send an AI frequency signal as in optional block 814. In some embodiments, an AI QoS manager may be configured to generate and send an AI frequency signal in optional block 820. In some embodiments, an I/O interface and/or memory controller/physical layer component may be configured to generate and send an AI frequency signal in optional block 820. The AI QoS device may repeatedly, periodically, or continuously receive AI QoS factors in block 802.

In response to determining not to curtail AI processor operating frequency (i.e., optional determination block 816=“No), the AI QoS device may receive AI QoS factors in block 802.

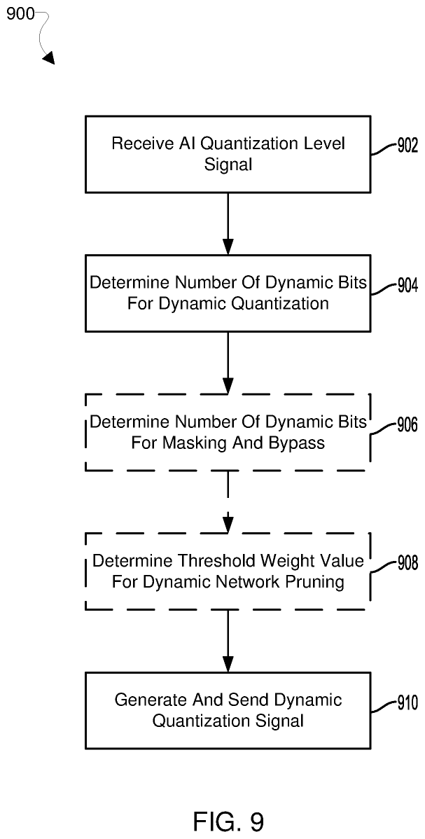

FIG. 9 illustrates a method 900 for dynamic neural network quantization architecture configuration control according to an embodiment. With reference to FIGS. 1-9, the method 900 may be implemented in a computing device (e.g., 100), in general purpose hardware, in dedicated hardware (e.g., dynamic quantization controller 208), in software executing in a processor (e.g., processor 104, AI processor 124, dynamic quantization controller 208, AI processing subsystem 300, AI processor 124a-124f, I/O interface 302, memory controller/physical layer component 304a-304t), or in a combination of a software-configured processor and dedicated hardware, such as a processor executing software within a dynamic neural network quantization system (e.g., AI processor 124, dynamic quantization controller 208. AI processing subsystem 300, AI processor 124a-124f, I/O interface 302, memory controller/physical layer component 304a-304f) that includes other individual components, and various memory/cache controllers. In order to encompass the alternative configurations enabled in various embodiments, the hardware implementing the method 900 is referred to herein as a “dynamic quantization device.” In some embodiments, the method 900 may be implemented following block 810 and/or optional block 814 of the method 800 (FIG. 8).

In block 902, the dynamic quantization device may receive an AI quantization level signal. The dynamic quantization device may receive the AI quantization level signal from an AI QoS device (e.g., AI QoS manager 210. I/O interface 302, memory controller/physical layer component 304a-304f). In some embodiments, a dynamic quantization controller may be configured to receive an AI quantization level signal in block 902. In some embodiments, an I/O interface and/or memory controller/physical layer component may be configured to receive an AI quantization level signal in block 902.

In block 904, the dynamic quantization device may determine a number of dynamic bits for dynamic quantization. The dynamic quantization device may use an AI quantization level received with the AI quantization level signal to determine the parameters for the dynamic neural network quantization reconfiguration. In some embodiments, the dynamic quantization device may also use operating conditions received with the AI quantization level signal to determine the parameters for the dynamic neural network quantization reconfiguration. In some embodiments, the dynamic quantization device may be configured with algorithms, thresholds, look up tables, etc. for determining which parameters and/or the values of the parameters of the dynamic neural network quantization reconfiguration to use based on the AI quantization level and/or the operating conditions. For example, the dynamic quantization device may use the AI quantization level and/or operating conditions as inputs to an algorithm that may output a number of dynamic bits to use for quantization of activation and weight values. In some embodiments, a dynamic quantization controller may be configured to determine a number of dynamic bits for dynamic quantization in block 904. In some embodiments, an I/O interface and/or memory controller/physical layer component may be configured to determine a number of dynamic bits for dynamic quantization in block 904.

In block optional 906, the dynamic quantization device may determine a number of dynamic bits for masking of activation and weight values and bypass of portions of MACs (e.g., 202a-202i). The dynamic quantization device may use an AI quantization level received with the AI quantization level signal to determine the parameters for the dynamic neural network quantization reconfiguration. In some embodiments, the dynamic quantization device may also use operating conditions received with the AI quantization level signal to determine the parameters for the dynamic neural network quantization reconfiguration. In some embodiments, the dynamic quantization device may be configured with algorithms, thresholds, look up tables, etc. for determining which parameters and/or the values of the parameters of the dynamic neural network quantization reconfiguration to use based on the AI quantization level and/or the operating conditions. For example, the dynamic quantization device may use the AI quantization level and/or operating conditions as inputs to an algorithm that may output a number of dynamic bits for masking of activation and weight values and bypass of portions of MACs. In some embodiments, a dynamic quantization controller may be configured to determine a number of dynamic bits for masking of activation and weight values and bypass of portions of MACs in optional block 906. In some embodiments, an I/O interface and/or memory controller/physical layer component may be configured to determine a number of dynamic bits for masking of activation and weight values and bypass of portions of MACs in optional block 906.

In block optional 908, the dynamic quantization device may determine a threshold weight value for dynamic network pruning. The dynamic quantization device may use an AI quantization level received with the AI quantization level signal to determine the parameters for the dynamic neural network quantization reconfiguration. In some embodiments, the dynamic quantization device may also use operating conditions received with the AI quantization level signal to determine the parameters for the dynamic neural network quantization reconfiguration. In some embodiments, the dynamic quantization device may be configured with algorithms, thresholds, look up tables, etc. for determining which parameters and/or the values of the parameters of the dynamic neural network quantization reconfiguration to use based on the AI quantization level and/or the operating conditions. For example, the dynamic quantization device may use the AI quantization level and/or operating conditions as inputs to an algorithm that may output a threshold weight value for masking of weight values and bypass of entire MACs (e.g., 202a-202i). In some embodiments, a dynamic quantization controller may be configured to determine a threshold weight value for dynamic network pruning in optional block 908. In some embodiments, an I/O interface and/or memory controller/physical layer component may be configured to determine a threshold weight value for dynamic network pruning in optional block 908.

The AI quantization level used in block 904, optional block 906, and/or optional block 906 may be different from a previously calculated AI quantization level and result in differences in the determined parameter for implementing dynamic neural network quantization reconfiguration. For example, increasing the AI quantization level may cause the dynamic quantization device to determine an increased number of dynamic bits and/or decreased threshold weight value for implementing dynamic neural network quantization reconfiguration. Increasing the number of dynamic bits and/or decreasing the threshold weight value may cause fewer bits and/or fewer MACs to be used to implement calculations of a neural network, which may reduce the accuracy of the neural network's inference results. As another example, decreasing the AI quantization level may cause the dynamic quantization device to determine a decreased number of dynamic bits and/or increased threshold weight value for implementing dynamic neural network quantization reconfiguration. Decreasing the number of dynamic bits and/or increasing the threshold weight value may cause more bits and/or more MACs to be used to implement calculations of a neural network, which may increase the accuracy of the neural network's inference results.

In block 910, the dynamic quantization device may generate and send a dynamic quantization signal. The dynamic quantization signal may include the parameters for the dynamic neural network quantization reconfiguration. The dynamic quantization device may send the dynamic quantization signal to dynamic neural network quantization logics (e.g., 212, 214). In some embodiments, the dynamic quantization device may send the dynamic quantization signal to an I/O interface and/or memory controller/physical layer component. The dynamic quantization signal may trigger the recipient to implement dynamic neural network quantization reconfiguration and provide the parameters for implementing the dynamic neural network quantization reconfiguration. In some embodiments, the dynamic quantization device may also send the dynamic quantization signal to the MAC array. The dynamic quantization signal may trigger the MAC array to implement dynamic neural network quantization reconfiguration and provide the parameters for implementing the dynamic neural network quantization reconfiguration. In some embodiments, the dynamic quantization signal may include an indicator of a type of dynamic neural network quantization reconfiguration to implement. In some embodiments, the indicator of type of dynamic neural network quantization reconfiguration may be the parameters for the dynamic neural network quantization reconfiguration. In some embodiments the types of dynamic neural network quantization reconfiguration may include: configuring the recipient for quantization of activation and weight values, configuring the recipient for masking of activation and weight values and the MAC array and/or MACs for bypass of portions of MACs, and configuring the recipient for masking of weight values and the MAC array and/or MACs for bypass of entire MACs. In some embodiments, a dynamic quantization controller may be configured to generate and send a dynamic quantization signal in block 910. In some embodiments, an I/O interface and/or memory controller/physical layer component may be configured to generate and send a dynamic quantization signal in block 910.

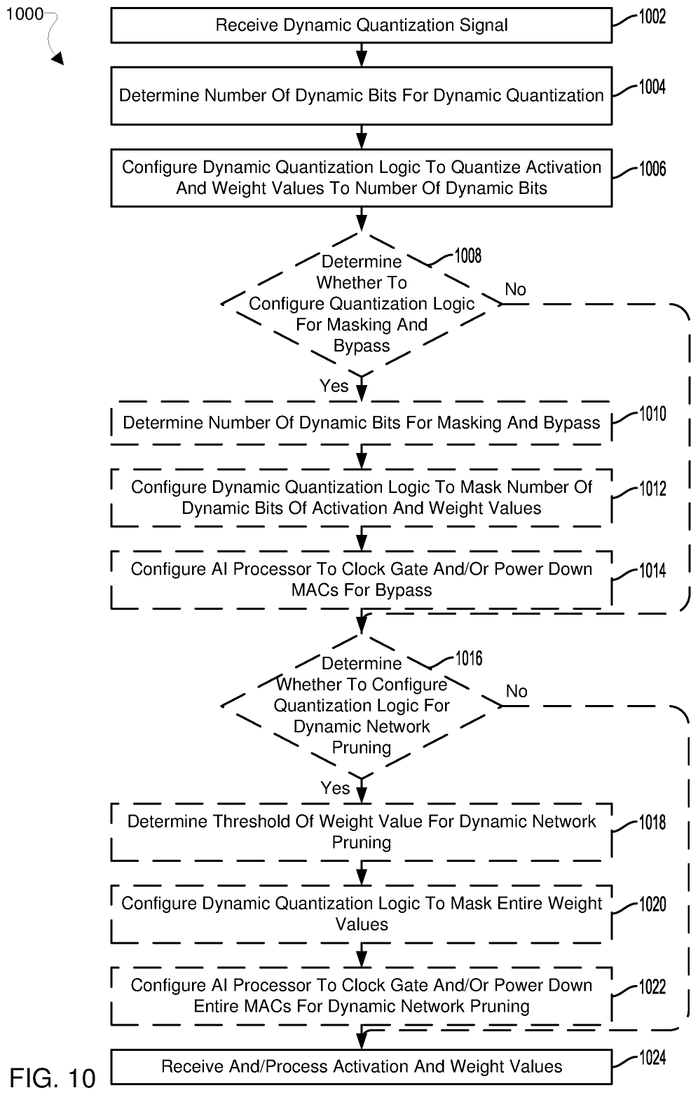

FIG. 10 illustrates a method 1000 for dynamic neural network quantization architecture reconfiguration according to an embodiment according to an embodiment. With reference to FIGS. 1-10, the method 1000 may be implemented in a computing device (e.g., 100), in general purpose hardware, in dedicated hardware (e.g., dynamic neural network quantization logics 212, 214, MAC array 200, MAC 202a-202i), in software executing in a processor (e.g., processor 104, AI processor 124. AI processing subsystem 300. AI processor 124a-124f, I/O interface 302, memory controller/physical layer component 304a-304f), or in a combination of a software-configured processor and dedicated hardware, such as a processor executing software within a dynamic neural network quantization system (e.g., AI processor 124, AI processing subsystem 300, AI processor 124a-124f, I/O interface 302, memory controller/physical layer component 304a-304f) that includes other individual components, and various memory/cache controllers. In order to encompass the alternative configurations enabled in various embodiments, the hardware implementing the method 1000 is referred to herein as a “dynamic quantization configuration device.” In some embodiments, the method 1000 may be implemented following block 910 of the method 900 (FIG. 9).

In block 1002, the dynamic quantization configuration device may receive a dynamic quantization signal. The dynamic quantization configuration device may receive the dynamic quantization signal from a dynamic quantization controller (e.g., dynamic quantization controller 208, I/O interface 302, memory controller/physical layer component 304a-304f). In some embodiments, a dynamic neural network quantization logic may be configured to receive a dynamic quantization signal in block 1002. In some embodiments, an I/O interface and/or memory controller/physical layer component may be configured to receive a dynamic quantization signal in block 1002. In some embodiments, a MAC array may be configured to receive a dynamic quantization signal in block 1002.

In block 1004, the dynamic quantization configuration device may determine a number of dynamic bits for dynamic quantization. The dynamic quantization configuration device may determine the parameters for the dynamic neural network quantization reconfiguration. The dynamic quantization signal may include the parameter of a number of dynamic bits for configuring dynamic neural network quantization logic (e.g., dynamic neural network quantization logics 212, 214, I/O interface 302, memory controller/physical layer component 304a-304f) for quantization of activation and weight values. In some embodiments, a dynamic neural network quantization logic may be configured to determine a number of dynamic bits for dynamic quantization in block 1004. In some embodiments, an I/O interface and/or memory controller/physical layer component may be configured to determine a number of dynamic bits for dynamic quantization in block 1004.

In block 1006, the dynamic quantization configuration device may configure dynamic neural network quantization logic to quantize activation and weight values to the number of dynamic bits. The dynamic neural network quantization logic may be configured to quantize the activation and weight values by rounding the bits of the activation and weight values to the number of dynamic bits indicated by the dynamic quantization signal. The dynamic neural network quantization logics may include configurable logic gates and/or software that may be configured to round the bits of the activation and weight values to the number of dynamic bits. In some embodiments, the logic gates and/or software may be configured to output zero values for the least significant bits of the activation and weight values up to and/or including the number of dynamic bits. In some embodiments, the logic gates and/or software may be configured to output the values of the most significant bits of the activation and weight values including and/or following the number of dynamic bits. For example, each bit of an activation or weight value may be input to the logic gates and/or software sequentially, such as least significant bit to most significant bit. The logic gates and/or software may output zero values for the least significant bits of the activation and weight values up to and/or including the number of dynamic bits indicated by the parameter. The logic gates and/or software may output the values for the most significant bits of the activation and weight values including and/or following the number of dynamic bits indicated by the parameter. The number of dynamic bits may be different than a default number of dynamic bits or a pervious number of dynamic bits to round to for a default or previous configuration of the dynamic neural network quantization logics. Therefore, the configuration of the logic gates may also be different from default or previous configurations of the logic gates and/or software. In some embodiments, a dynamic neural network quantization logic may be configured to configure dynamic neural network quantization logic to quantize activation and weight values to the number of dynamic bits in block 1006. In some embodiments, an I/O interface and/or memory controller/physical layer component may be configured to configure dynamic neural network quantization logic to quantize activation and weight values to the number of dynamic bits in block 1006.

In optional determination block 1008, the dynamic quantization configuration device may determine whether to configure quantization logic for masking and bypass. The dynamic quantization signal may include the parameter of a number of dynamic bits for configuring the dynamic neural network quantization logic for masking of activation and weight values and bypass of portions of MACs. The dynamic quantization configuration device may determine from the presence of a value for the parameter to configure quantization logic for masking and bypass. In some embodiments, a dynamic neural network quantization logic may be configured to determine whether to configure quantization logic for masking and bypass in optional determination block 1008. In some embodiments, an I/O interface and/or memory controller/physical layer component may be configured to determine whether to configure quantization logic for masking and bypass in optional determination block 1008. In some embodiments, a MAC array may be configured to determine whether to configure quantization logic for masking and bypass in optional determination block 1008.

In response to determining to configure quantization logic for masking and bypass (i.e., option determination block 1008=“Yes), the dynamic quantization configuration device may determine a number of dynamic bits for masking and bypass in optional block 1010. As described above, the dynamic quantization signal may include the parameter of a number of dynamic bits for configuring the dynamic neural network quantization logic (e.g., dynamic neural network quantization logics 212, 214. MAC array 200. I/O interface 302, memory controller/physical layer component 304a-304f) for masking of activation and weight values and bypass of portions of MACs. The dynamic quantization configuration device may retrieve the number of dynamic bits for masking and bypass from the dynamic quantization signal. In some embodiments, a dynamic neural network quantization logic may be configured to determine a number of dynamic bits for masking and bypass in optional block 1010. In some embodiments, an I/O interface and/or memory controller/physical layer component may be configured to determine a number of dynamic bits for masking and bypass in optional block 1010. In some embodiments, a MAC array may be configured to determine a number of dynamic bits for masking and bypass in optional block 1010.

In optional block 1012, the dynamic quantization configuration device may configure dynamic quantization logic to mask a number of dynamic bits of the activation and weight values. The dynamic neural network quantization logic may be configured to quantize the activation and weight values by masking the number of dynamic bits of the activation and weight values indicated by the dynamic quantization signal.

The dynamic neural network quantization logic may include configurable logic gates and/or software that may be configured to mask the number of dynamic bits of the activation and weight values. In some embodiments, the logic gates and/or software may be configured to output zero values for the least significant bits of the activation and weight values up to and/or including the number of dynamic bits. In some embodiments, the logic gates and/or software may be configured to output the values of the most significant bits of the activation and weight values including and/or following the number of dynamic bits. For example, each bit of an activation and weight values may be input to the logic gates and/or software sequentially, such as least significant bit to most significant bit. The logic gates and/or software may output zero values for the least significant bits of the activation and weight values up to and/or including the number of dynamic bits indicated by the parameter. The logic gates and/or software may output the values for the most significant bits of the activation and weight values including and/or following the number of dynamic bits indicated by the parameter. The number of dynamic bits may be different than a default number of dynamic bits or a pervious number of dynamic bits to mask for a default or previous configuration of the dynamic neural network quantization logic. Therefore, the configuration of the logic gates and/or software may also be different from default or previous configurations of the logic gates.

In some embodiments, the logic gates may be clock gated so that the logic gates do not receive and/or do not output the least significant bits of the activation and weight values up to and/or including the number of dynamic bits. Clock gating the logic gates may effectively replace the least significant bits of the activation and weight values with zero values as the MAC array may not receive the values of the least significant bits of the activation and weight values. In some embodiments, a dynamic neural network quantization logic may be configured to configure dynamic quantization logic to mask a number of dynamic bits of the activation and weight values in optional block 1012. In some embodiments, an I/O interface and/or memory controller/physical layer component may be configured to configure dynamic quantization logic to mask a number of dynamic bits of the activation and weight values in optional block 1012.

In optional block 1014, the dynamic quantization configuration device may configure an AI processor to clock gate and/or power down MACs for bypass. In some embodiments, the dynamic neural network quantization logic may signal to the MAC array, of the AI processor, the parameter of the number of dynamic bits for bypass of portions of MACs. In some embodiments, the dynamic neural network quantization logic may signal to the MAC array which of the bits of the activation and weight values are masked. In some embodiments, the lack of a signal for a bit of the activation and weight values may be the signal from the dynamic neural network quantization logic to the MAC array. The MAC array may receive the dynamic quantization signal including the parameter of a number of dynamic bits for configuring the dynamic neural network quantization logic for masking of activation and weight values and bypass of portions of MACs. In some embodiments the MAC array 200 may receive the signal of the parameter of a number of dynamic bits and or which dynamic bits for bypass of portions of MACs from the dynamic neural network quantization logic. The MAC array may be configured to bypass portions of MACs for dynamic bits of the activation and weight values indicated by the dynamic quantization signal and/or the signal from the dynamic neural network quantization logic. These dynamic bits may correspond to bits of the activation and weight values masked by the dynamic neural network quantization logic. The MACs may include logic gates configured to implement multiply and accumulate functions.

In some embodiments, the MAC array may clock gate the logic gates of the MACs configured to multiply and accumulate the bits of the activation and weight values that correspond to the number of dynamic bits indicated by the parameter of the dynamic quantization signal. In some embodiments, the MAC array may clock gate the logic gates of the MACs configured to multiply and accumulate the bits of the activation and weight values that correspond to the number of dynamic bits and/or the dynamic significant bits indicated by the signal from the dynamic neural network quantization logic.

In some embodiments, the MAC array may power collapse the logic gates of the MACs configured to multiply and accumulate the bits of the activation and weight values that correspond to the number of dynamic bits indicated by the parameter of the dynamic quantization signal. In some embodiments, the MAC array may power collapse the logic gates of the MACs configured to multiply and accumulate the bits of the activation and weight values that correspond to the number of dynamic bits and/or the specific dynamic bits indicated by the signal from the dynamic neural network quantization logics.

By clock gating and/or powering down the logic gates of the MACs in optional block 1014, the MACs may not receive the bits of the activation and weight values that correspond to the number of dynamic bits or specific dynamic bits, effectively masking these bits. In some embodiments, a MAC array may be configured to configure an AI processor to clock gate and/or power down MACs for bypass in optional block 1014.

In some embodiments, following configuring dynamic neural network quantization logic to quantize activation and weight values to the number of dynamic bits in block 1006, the dynamic quantization configuration device may determine whether to configure quantization logic for dynamic network pruning in optional determination block 1016. In some embodiments, in response to determining not to configure quantization logic for masking and bypass (i.e., optional determination block 1018=“No), or following configuring an AI processor to clock gate and/or power down MACs for bypass in optional block 1014, the dynamic quantization configuration device may determine whether to configure quantization logic for dynamic network pruning in optional determination block 1016. The dynamic quantization signal may include the parameter of a threshold weight value for configuring the dynamic neural network quantization logic for masking of weight values and bypass of entire MACs. The dynamic quantization configuration device may determine from the presence of a value for the parameter to configure quantization logic for dynamic network pruning. In some embodiments, a dynamic neural network quantization logic may be configured to determine whether to configure quantization logic for dynamic network pruning in optional determination block 1016. In some embodiments, an I/O interface and/or memory controller/physical layer component may be configured to determine whether to configure quantization logic for dynamic network pruning in optional determination block 1016. In some embodiments, a MAC array may be configured to determine whether to configure quantization logic for dynamic network pruning in optional determination block 1016.

In response to determining to configure quantization logic for dynamic network pruning (i.e., option determination block 1016=“Yes), the dynamic quantization configuration device may determine a threshold weight value for dynamic network pruning in optional block 1018. As described above, the dynamic quantization signal may include the parameter of a threshold weight value for configuring the dynamic neural network quantization logic (e.g., dynamic neural network quantization logics 212, 214, MAC array 200, I/O interface 302, memory controller/physical layer component 304a-304f) for masking of entire weight values and bypass of entire MACs. The dynamic quantization configuration device may retrieve the threshold weight value for masking and bypass from the dynamic quantization signal. In some embodiments, a dynamic neural network quantization logic may be configured to determine a threshold weight value for dynamic network pruning in optional block 1018. In some embodiments, an I/O interface and/or memory controller/physical layer component may be configured to determine a threshold weight value for dynamic network pruning in optional block 1018. In some embodiments, a MAC array may be configured to determine a threshold weight value for dynamic network pruning in optional block 1018.

In optional block 1020, the dynamic quantization configuration device may configure dynamic quantization logic to mask entire weight values. The dynamic neural network quantization logic may be configured to quantize the weight values by masking all of the bits of the weight values based on comparison of the weight values to the threshold weight value indicated by the dynamic quantization signal. The dynamic neural network quantization logic may include configurable logic gates and/or software that may be configured to compare weight values received from a data source (e.g., weight buffer 204) to the threshold weight value and mask the weight values that compare unfavorably, such as by being less than or less than and equal to, the threshold weight value. In some embodiments, the comparison may be of the absolute value of a weight value to the threshold weight value. In some embodiments, the logic gates and/or software may be configured to output zero values for all of the bits of the weight values that compare unfavorably to the threshold weight value. All of the bits may be a different number of bits than a default number of bits or a pervious number of bits to mask for a default or previous configuration of the dynamic neural network quantization logic. Therefore, the configuration of the logic gates and/or software may also be different from default or previous configurations of the logic gates. In some embodiments, the logic gates may be clock gated so that the logic gates do not receive and/or do not output the bits of the weight values that compare unfavorably to the threshold weight value. Clock gating the logic gates may effectively replace the bits of the weight values with zero values as the MAC array may not receive the values of the bits of the weight values. In some embodiments, a dynamic neural network quantization logic may be configured to configure dynamic quantization logic to mask entire weight values in optional block 1020. In some embodiments, an I/O interface and/or memory controller/physical layer component may be configured to configure dynamic quantization logic to entire weight values in optional block 1020.

In optional block 1022, the dynamic quantization configuration device may configure an AI processor to clock gate and/or power down entire MACs for dynamic network pruning. In some embodiments, the dynamic neural network quantization logic may signal to the MAC array, of the AI processor, which of the bits of the weight values are masked. In some embodiments, the lack of a signal for a bit of the weight values may be the signal from the dynamic neural network quantization logic to the MAC array. In some embodiments, the MAC array may receive the signal from the dynamic neural network quantization logic for which bits of the weight values are masked. The MAC array may interpret masked entire weight values as signals to bypass entire MACs. The MAC array may be configured to bypass MACs for weight values indicated by the signal from the dynamic neural network quantization logic. These weight values may correspond to weight values masked by the dynamic neural network quantization logic. The MACs may include logic gates configured to implement multiply and accumulate functions. In some embodiments, the MAC array may clock gate the logic gates of the MACs configured to multiply and accumulate the bits of the weight values that correspond to the masked weight values. In some embodiments, the MAC array may power collapse the logic gates of the MACs configured to multiply and accumulate the bits of the weight values that correspond to masked weight values. By clock gating and/or powering down the logic gates of the MACs, the MACs not receive the bits of the activation and weight values that correspond to the masked weight values. In some embodiments, a MAC array may be configured to configure an AI processor to clock gate and/or power down MACs for dynamic network pruning in optional block 1022.

Masking weight values by the dynamic neural network quantization logic in optional block 1020 and/or clock gating and/or powering down MACs in optional block 1022 may prune a neural network executed by the MAC array. Removing weight values and MAC operations form the neural network may effectively remove synapses and nodes from the neural network. The weight threshold may be determined on a basis that weight values that compare unfavorably to the weight threshold when removed from the execution of the neural network may cause an acceptable loss in accuracy in the AI processor results.

In some embodiments, following configuring dynamic neural network quantization logic to quantize activation and weight values to the number of dynamic bits in block 1006, the dynamic quantization configuration device may receive and process activation and weight values in block 1024. In some embodiments, in response to determining not to configure quantization logic for masking and bypass (i.e., optional determination block 1018=“No), or following configuring an AI processor to clock gate and/or power down MACs for bypass in optional block 1014, the dynamic quantization configuration device may receive and process activation and weight values in block 1024. In some embodiments, in response to determining not to configure quantization logic for dynamic network pruning (i.e., option determination block 1016=“No), or following configuring an AI processor to clock gate and/or power down MACs for dynamic network pruning in optional block 1022, the dynamic quantization configuration device may receive and process activation and weight values in block 1024. The dynamic quantization configuration device may receive the activation and weight values from a data source (e.g., processor 104, communication component 112, memory 106, 114, peripheral device 122, weight buffer 204, activation buffer 206, memory 106). The quantization configuration device may quantize and/or mask activation values and/or weight values. The quantization device may bypass, clock gate, and/or power down portions of and/or entire MACs. In some embodiments, a dynamic neural network quantization logic may be configured to receive and process activation and weight values in block 1024. In some embodiments, an I/O interface and/or memory controller/physical layer component may be configured to receive and process activation and weight values in block 1024. In some embodiments, a MAC array may be configured to receive and process activation and weight values in block 1024.

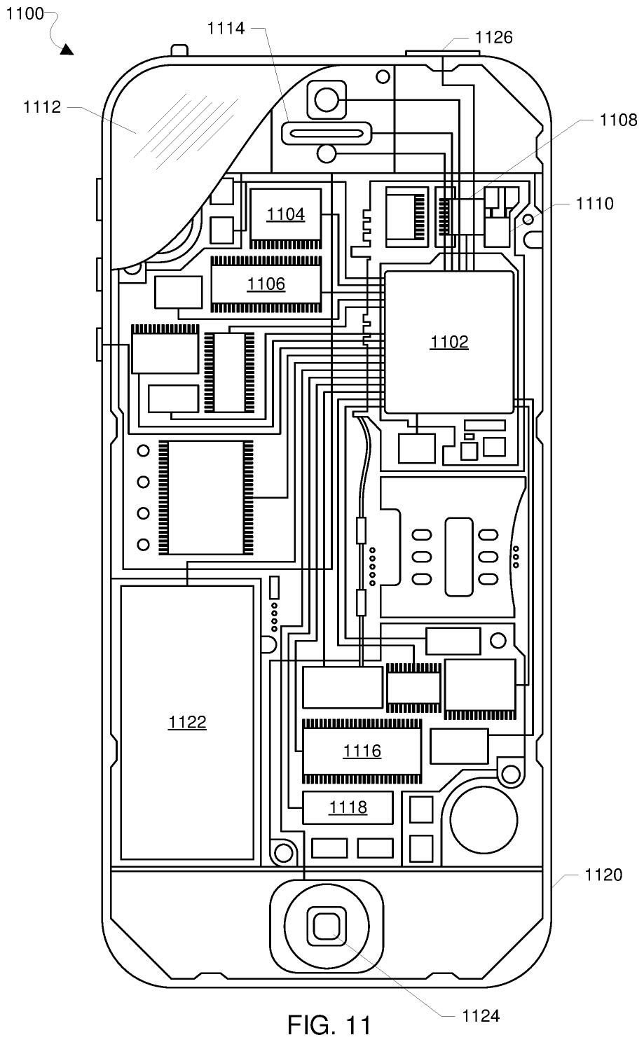

An AI processor in accordance with the various embodiments (including, but not limited to, embodiments described above with reference to FIGS. 1-10) may be implemented in a wide variety of computing systems including mobile computing devices, an example of which suitable for use with the various embodiments is illustrated in FIG. 11. The mobile computing device 1100 may include a processor 1102 coupled to a touchscreen controller 1104 and an internal memory 1106. The processor 1102 may be one or more multicore integrated circuits designated for general or specific processing tasks. The internal memory 1106 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STI-RAM, and embedded DRAM. The touchscreen controller 1104 and the processor 1102 may also be coupled to a touchscreen panel 1112, such as a resistive-sensing touchscreen, capacitive-sensing touchscreen, infrared sensing touchscreen, etc. Additionally, the display of the mobile computing device 1100 need not have touch screen capability.

The mobile computing device 1100 may have one or more radio signal transceivers 1108 (e.g., Peanut, Bluetooth, ZigBee, Wi-Fi, RF radio) and antennae 1110, for sending and receiving communications, coupled to each other and/or to the processor 1102. The transceivers 1108 and antennae 1110 may be used with the above-mentioned circuitry to implement the various wireless transmission protocol stacks and interfaces. The mobile computing device 1100 may include a cellular network wireless modem chip 1116 that enables communication via a cellular network and is coupled to the processor.

The mobile computing device 1100 may include a peripheral device connection interface 1118 coupled to the processor 1102. The peripheral device connection interface 1118 may be singularly configured to accept one type of connection, or may be configured to accept various types of physical and communication connections, common or proprietary, such as Universal Serial Bus (USB), FireWire, Thunderbolt, or PCIe. The peripheral device connection interface 1118 may also be coupled to a similarly configured peripheral device connection port (not shown).

The mobile computing device 1100 may also include speakers 1114 for providing audio outputs. The mobile computing device 1100 may also include a housing 1120, constructed of a plastic, metal, or a combination of materials, for containing all or some of the components described herein. The mobile computing device 1100 may include a power source 1122 coupled to the processor 1102, such as a disposable or rechargeable battery. The rechargeable battery may also be coupled to the peripheral device connection port to receive a charging current from a source external to the mobile computing device 1100. The mobile computing device 1100 may also include a physical button 1124 for receiving user inputs. The mobile computing device 1100 may also include a power button 1126 for turning the mobile computing device 1100 on and off.

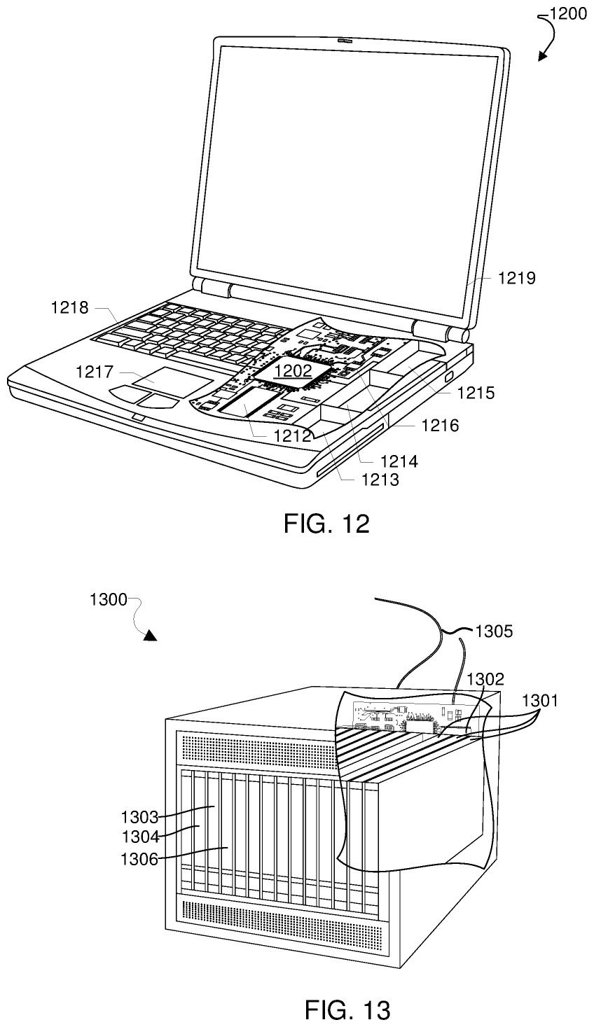

An AI processor in accordance with the various embodiments (including, but not limited to, embodiments described above with reference to FIGS. 1-10) may be implemented in a wide variety of computing systems include a laptop computer 1200 an example of which is illustrated in FIG. 12. Many laptop computers include a touchpad touch surface 1217 that serves as the computer's pointing device, and thus may receive drag, scroll, and flick gestures similar to those implemented on computing devices equipped with a touch screen display and described above. A laptop computer 1200 will typically include a processor 1202 coupled to volatile memory 1212 and a large capacity nonvolatile memory, such as a disk drive 1213 of Flash memory. Additionally, the computer 1200 may have one or more antenna 1215 for sending and receiving electromagnetic radiation that may be connected to a wireless data link and/or cellular telephone transceiver 1216 coupled to the processor 1202. The computer 1200 may also include a floppy disc drive 1214 and a compact disc (CD) drive 1215 coupled to the processor 1202. In a notebook configuration, the computer housing includes the touchpad 1217, the keyboard 1218, and the display 1219 all coupled to the processor 1202. Other configurations of the computing device may include a computer mouse or trackball coupled to the processor (e.g., via a USB input) as are well known, which may also be used in conjunction with the various embodiments.

An AI processor in accordance with the various embodiments (including, but not limited to, embodiments described above with reference to FIGS. 1-10) may also be implemented in fixed computing systems, such as any of a variety of commercially available servers. An example server 1300 is illustrated in FIG. 13. Such a server 1300 typically includes one or more multicore processor assemblies 1301 coupled to volatile memory 1302 and a large capacity nonvolatile memory, such as a disk drive 1304. As illustrated in FIG. 13, multicore processor assemblies 1301 may be added to the server 1300 by inserting them into the racks of the assembly. The server 1300 may also include a floppy disc drive, compact disc (CD) or digital versatile disc (DVD) disc drive 1306 coupled to the processor 1301. The server 1300 may also include network access ports 1303 coupled to the multicore processor assemblies 1301 for establishing network interface connections with a network 1305, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Implementation examples are described in the following paragraphs. While some of the following implementation examples are described in terms of example methods, further example implementations may include: the example methods discussed in the following paragraphs implemented by an AI processor comprising a dynamic quantization controller and a MAC array configured to perform operations of the example methods; a computing device comprising an AI processor comprising a dynamic quantization controller and a MAC array configured to perform operations of the example methods; and the example methods discussed in the following paragraphs implemented by an AI processor including means for performing functions of the example methods.

Example 1. A method for processing a neural network by an artificial intelligence (AI) processor, the method including: receiving an AI processor operating condition information; dynamically adjusting an AI quantization level for a segment of the neural network in response to the operating condition information; and processing the segment of the neural network using the adjusted AI quantization level.

Example 2. The method of example 1, in which dynamically adjusting the AI quantization level for the segment of the neural network includes: increasing the AI quantization level in response to the operating condition information indicating a level of the operating condition that increased constraint of a processing ability of the AI processor, and decreasing the AI quantization level in response to operating condition information indicating a level of the operating condition that decreased constraint of the processing ability of the AI processor.

Example 3. The method of any of examples 1 or 2, in which the operating condition information is at least one of the group of a temperature, a power consumption, an operating frequency, or a utilization of processing units.

Example 4. The method of any of examples 1-3, in which dynamically adjusting the AI quantization level for the segment of the neural network includes adjusting the AI quantization level for quantizing weight values to be processed by the segment of the neural network.

Example 5. The method of any of examples 1-3, in which dynamically adjusting the AI quantization level for the segment of the neural network includes adjusting the AI quantization level for quantizing activation values to be processed by the segment of the neural network.

Example 6. The method of any of examples 1-3, in which dynamically adjusting the AI quantization level for the segment of the neural network includes adjusting the AI quantization level for quantizing weight values and activation values to be processed by the segment of the neural network.

Example 7. The method of any of examples 1-6, in which: the AI quantization level is configured to indicate dynamic bits of a value to be processed by the neural network to quantize; and processing the segment of the neural network using the adjusted AI quantization level includes bypassing portions of a multiplier accumulator (MAC) associated with the dynamic bits of the value.

Example 8. The method of any of examples 1-7, further including: determining an AI quality of service (QoS) value using AI QoS factors; and determining the AI quantization level to achieve the AI QoS value.

Example 9. The method of example 8, in which the AI QoS value represents a target for accuracy of a result generated by the AI processor and throughput of the AI processor.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM. ROM. EEPROM, FLASH memory. CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method for processing a neural network by an artificial intelligence (AI) processor, the method comprising:
receiving an AI processor operating condition information:
dynamically adjusting an AI quantization level for a segment of the neural network in response to the operating condition information; and
processing the segment of the neural network using the adjusted AI quantization level.

2. The method of claim 1, wherein dynamically adjusting the AI quantization level for the segment of the neural network comprises:
increasing the AI quantization level in response to the operating condition information indicating a level of an operating condition that increased constraint of a processing ability of the AI processor, and
decreasing the AI quantization level in response to operating condition information indicating a level of the operating condition that decreased constraint of the processing ability of the AI processor.

3. The method of claim 1, wherein the operating condition information is at least one of the group of a temperature, a power consumption, an operating frequency, or a utilization of processing units.

4. The method of claim 1, wherein dynamically adjusting the AI quantization level for the segment of the neural network comprises adjusting the AI quantization level for quantizing weight values to be processed by the segment of the neural network.

5. The method of claim 1, wherein dynamically adjusting the AI quantization level for the segment of the neural network comprises adjusting the AI quantization level for quantizing activation values to be processed by the segment of the neural network.

6. The method of claim 1, wherein dynamically adjusting the AI quantization level for the segment of the neural network comprises adjusting the AI quantization level for quantizing weight values and activation values to be processed by the segment of the neural network.

7. The method of claim 1, wherein:
the AI quantization level is configured to indicate dynamic bits of a value to be processed by the neural network to quantize; and
processing the segment of the neural network using the adjusted AI quantization level comprises bypassing portions of a multiplier accumulator (MAC) associated with the dynamic bits of the value.

8. The method of claim 1, further comprising:
determining an AI quality of service (QoS) value using AI QoS factors; and
determining the AI quantization level to achieve the AI QoS value.

9. The method of claim 8, wherein the AI QoS value represents a target for accuracy of a result generated by the AI processor and throughput of the AI processor.

10. An artificial intelligence (AI) processor, comprising:
a dynamic quantization controller configured to:
receive an AI processor operating condition information; and
dynamically adjust an AI quantization level for a segment of a neural network in response to the operating condition information; and
a multiplier accumulator (MAC) array configured to process the segment of the neural network using the adjusted AI quantization level.

11. The AI processor of claim 10, wherein the dynamic quantization controller is configured such that dynamically adjusting the AI quantization level for the segment of the neural network comprises:
increasing the AI quantization level in response to the operating condition information indicating a level of an operating condition that increased constraint of a processing ability of the AI processor, and
decreasing the AI quantization level in response to operating condition information indicating a level of the operating condition that decreased constraint of the processing ability of the AI processor.

12. The AI processor of claim 10, wherein the dynamic quantization controller is configured such that the operating condition information is at least one of the group of a temperature, a power consumption, an operating frequency, or a utilization of processing units.

13. The AI processor of claim 10, wherein the dynamic quantization controller is configured such that dynamically adjusting the AI quantization level for the segment of the neural network comprises adjusting the AI quantization level for quantizing weight values to be processed by the segment of the neural network.

14. The AI processor of claim 10, wherein the dynamic quantization controller is configured such that dynamically adjusting the AI quantization level for the segment of the neural network comprises adjusting the AI quantization level for quantizing activation values to be processed by the segment of the neural network.

15. The AI processor of claim 10, wherein the dynamic quantization controller is configured such that dynamically adjusting the AI quantization level for the segment of the neural network comprises adjusting the AI quantization level for quantizing weight values and activation values to be processed by the segment of the neural network.

16. The AI processor of claim 10, wherein:
the AI quantization level is configured to indicate dynamic bits of a value to be processed by the neural network to quantize; and
the MAC array is configured such tat processing the segment of the neural network using the adjusted AI quantization level comprises bypassing portions of a MAC associated with the dynamic bits of the value.

17. The AI processor of claim 10, further comprising an AI quality of service (QoS) device configured to:
determine an AI QoS value using AI QoS factors in response to determining to dynamically configure neural network quantization; and
determine the AI quantization level to achieve the AI QoS value.

18. The AI processor of claim 17, wherein the AI QoS device is configured such that the AI QoS value represents a target for accuracy of a result generated by the AI processor and throughput of the AI processor.

19. A computing device, comprising
an artificial intelligence (AI) processor comprising a dynamic quantization controller configured to:
receive an AI processor operating condition information; and
dynamically adjust an AI quantization level for a segment of a neural network in response to the operating condition information; and
the AI processor further comprising a multiplier accumulator (MAC) array configured to process the segment of the neural network using the adjusted AI quantization level.

20. The computing device of claim 19, wherein the dynamic quantization controller is configured to dynamically adjust the AI quantization level for the segment of the neural network by:
increasing the AI quantization level in response to the operating condition information indicating a level of an operating condition that increased constraint of a processing ability of the AI processor, and
decreasing the AI quantization level in response to operating condition information indicating a level of the operating condition that decreased constraint of the processing ability of the AI processor.

21. The computing device of claim 19, wherein the dynamic quantization controller is configured such that the operating condition information is at least one of the group of a temperature, a power consumption, an operating frequency, or a utilization of processing units.

22. The computing device of claim 19, wherein the dynamic quantization controller is configured to dynamically adjust the AI quantization level for the segment of the neural network by adjusting the AI quantization level for quantizing weight values to be processed by the segment of the neural network.

23. The computing device of claim 19, wherein the dynamic quantization controller is configured to dynamically adjust the AI quantization level for the segment of the neural network by adjusting the AI quantization level for quantizing activation values to be processed by the segment of the neural network.

24. The computing device of claim 19, wherein the dynamic quantization controller is configured to dynamically adjust the AI quantization level for the segment of the neural network by adjusting the AI quantization level for quantizing weight values and activation values to be processed by the segment of the neural network.

25. The computing device of claim 19, wherein:
the AI quantization level is configured to indicate dynamic bits of a value to be processed by the neural network to quantize; and
the MAC array is configured to process the segment of the neural network using the adjusted AI quantization level by bypassing portions of a MAC associated with the dynamic bits of the value.

26. The computing device of claim 19, further comprising an AI quality of service (QoS) device configured to:
determine an AI QoS value using AI QoS factors; and
determine the AI quantization level to achieve the AI QoS value.

27. The computing device of claim 26, wherein the AI QoS device is configured such that the AI QoS value represents a target for accuracy of a result generated by the AI processor and throughput of the AI processor.

28. An artificial intelligence (AI) processor, comprising:
means for receiving operating condition information of an AI processor;
means for dynamically adjusting an AI quantization level for a segment of a neural network in response to the operating condition information; and
means for processing the segment of the neural network using the adjusted AI quantization level.

29. The AI processor of claim 28, wherein means for dynamically adjusting the AI quantization level for the segment of the neural network comprises:
means for increasing the AI quantization level in response to the operating condition information indicating a level of an operating condition that increased constraint of a processing ability of the AI processor, and
means for decreasing the AI quantization level in response to operating condition information indicating a level of the operating condition that decreased constraint of the processing ability of the AI processor.

30. The AI processor of claim 28, wherein the operating condition information is at least one of the group of a temperature, a power consumption, an operating frequency, or a utilization of processing units.
